(19) United States
(12) Patent Application Publication
(10) Pub. No.: US 2023/0394993 A1
(43) Pub. Date: Dec. 7, 2023

(54) IDENTIFICATION AND TRACKING DEVICES

(71) Applicant: 13104133 CANADA LIMITED, Manitoba (CA)

(72) Inventor: Ellery Ross BURTON, Manitoba (CA)

(21) Appl. No.: 18/249,867

(22) PCT Filed: Oct. 20, 2021
(86) PCT No.: PCT/CA2021/051476

§ 371 Date: Apr. 20, 2023

Related U.S. Application Data
(60) Provisional application No. 63/094,065, filed on Oct. 20, 2020.

(51) Int. Cl. G09F 3/00; A01K 11/00

(52) U.S. Cl. CPC G09F 3/0291; G09F 3/0297; A01K 11/004

(57) ABSTRACT

Provided herein are identification elements for subject(s) or article(s) or interest, such as livestock animals, including: an attachment fitting for securing the identification element to a subject or article of interest; and a unique identifier element affixed to, integrated with, or embedded in the attachment fitting; wherein at least a portion of the attachment fitting is formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the subject or article of interest. Related methods and uses for tracking and/or identification of subject(s) or article(s) are also provided herein.

### FIELD OF INVENTION

The present invention relates generally to identification and/or tracking devices. More specifically, the present invention relates to identification tags for tracking and/or identification of livestock.

### BACKGROUND

Identification and tracking devices are becoming increasingly important for agriculture, livestock, and farming industries. The ability to identify and distinguish farm animals allows for individualized monitoring and tracking of each animal, and can greatly facilitate the identification of sick animals, monitoring of animal growth and/or production, monitoring of animal location, and performance or tracking of various other activities or metrics of interest.

Animal identification and tracking devices are especially important in the meat industry, as proper animal tracking can help to prevent disease outbreaks among livestock, and can facilitate food recalls in the event of contamination.

Traditional identification and tracking devices for livestock typically comprise bands, tags, or clips that are attached to the animal, or tattoos that are applied to the animal. Conventional bands, tags, or clips are often tied or fastened to the animal in a permanent or semi-permanent fashion such that they cannot be removed without deliberate and direct action by the farmer. This is done to prevent the devices from falling off unintentionally, and to prevent the devices from being removed by the animals, through mechanical damage, and general wear-and-tear. Examples of conventional identification and tracking devices may include those commercially available from Valley Vet (https://www.valleyvet.com/ct_detail.html?pgguid=4BD0DB3E-3399-41D2-9929BE0889DA3C79), for example.

One common type of ID and tracking device is an ear tag, in which an ear of the animal is pierced and a tag is installed on the ear at the piercing, the tag providing information for uniquely identifying the animal (often in the form of a printed label, a barcode, or an RFID identifier, for example). The ear tag is often fastened via a rivet or snap-type mechanism such that it permanently remains on the animal's ear throughout the animal's life. For removal, the ear tag is typically manually detached, clipped, or cut off by the farmer or a meat production worker.

However, such conventional ID and tracking devices present problems for meat production from the tagged animals. Additional time and labour is invested to remove the tags from the animals prior to production of the meat, and risk mitigation steps must be taken to ensure the tags or fragments thereof do not inadvertently contaminate the food products derived from the animals. Removal of ID and tracking devices is often one of the initial steps in the meat production process, and can be burdensome.

Alternative, additional, and/or improved identification and tracking devices, and methods and uses thereof, are desirable.

### SUMMARY OF INVENTION

Provided herein are identification and tracking devices that are attachable to an article or subject of interest, typically a livestock animal, or an article requiring cleaning and/or disinfection that are long-lasting and remain intact under normal conditions, but which are easily removable through artificial application of heat, typically in the form of hot water, steam, or flame. The identification and tracking devices described herein comprise a unique identifier element, and an attachment fitting for securing the identification element to the article or subject of interest, wherein at least a portion of the attachment fitting is formed of a heat-releasable material which is solid at normal environmental temperatures and conditions, but which dissolves, melts, disintegrates, degrades, and/or evaporates upon artificial heating above normal environmental temperatures, such that heating results in removal or detachment of the identification element from the article or subject of interest.

In the meat production industry, for example, it is contemplated that such identification elements as described herein may be used for identification and/or tracking of livestock. In order to prepare meat from the livestock animal, the carcass is often subjected to a scalding or flame-based hair removal stage as part of routine meat processing, and identification elements as described herein may be configured to be removed or detached from the carcass during such scalding or flame-based processing without requiring direct manipulation by the farmer or meat production worker, thereby avoiding a laborious removal step that is performed for conventional tags and reducing risk of tags inadvertently contaminating meat products due to forgotten tags. In certain embodiments, as described below, identification elements as described herein may even be designed and configured such that risk of foreign material remaining in the final food product is minimized or eliminated due to the identification element being removed or detached by the artificial heating treatment process, or even completely dissolved by the artificial heating. Identification elements as described herein may be formed, in whole or in part, of a heat-releasable material. In some examples, the identification element may be fully dissolved, melted, disintegrated, degraded, and/or evaporated upon artificial heating, simplifying clean-up and disposal of removed identification elements. In other examples, at least part of the identification element (such as the unique identifier element, for example) may remain intact following artificial heating, such that it can be recovered and reused.

It is additionally contemplated that identification elements as described herein may be configured and used for any of a wide variety of applications, and may be used to identify and/or track a wide variety of different articles or subjects. By way of example, it is contemplated that identification elements as described herein may be used for identification and/or tracking of articles or batches of clothing or other such materials to be laundered or sanitized. In such applications, it is contemplated that the burdensome step of removing conventional labels/tags from articles of clothing prior to cleaning in a washing machine can be avoided, as the identification elements as described herein may be configured to automatically remove or detach upon exposure to the hot water conditions in the clothes washing machine, for example.

In an embodiment, there is provided herein an identification element for livestock, comprising:
an attachment fitting for securing the identification element to a livestock animal; and
a unique identifier element affixed to, integrated with, or embedded in the attachment fitting;
at least a portion of the attachment fitting being formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal.

In another embodiment of the above identification element, the heat-releasable material may dissolve, melt, disintegrate, degrade, and/or evaporate upon artificial heating above a temperature of at least about 50° C.

In still another embodiment of any of the above identification element or identification elements, the heat-releasable material may dissolve, melt, disintegrate, degrade, and/or evaporate upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more.

In yet another embodiment of any of the above identification element or identification elements, the heat-releasable material may completely dissolve, melt, disintegrate, degrade, and/or evaporate upon artificial heating for about 1 hour or less.

In another embodiment of any of the above identification element or identification elements, the heat-releasable material may completely dissolve, melt, disintegrate, degrade, and/or evaporate upon artificial heating for 10 minutes, 9 minutes, 8 minutes, 7 minutes, 6 minutes, 5 minutes, 4 minutes, 3 minutes, 2 minutes, or less.

In still another embodiment of any of the above identification element or identification elements, the heat-releasable material may comprise a polymer material or resin.

In still another embodiment of any of the above identification element or identification elements, the heat-releasable material, polymer material, or resin may comprise one or more of a polyvinyl alcohol; an alkali-soluble resin; cellulose; a cellulose chemical derivative; a hydrophylic polymer; carboxymethyl cellulose; hydroxyethyl cellulose; Polyox; alginate; polyacrylamide; poly(acrylic acid); poly(methacrylic acid); polyethylene oxide; a starch; or a gelatin; or any combinations thereof; wherein the heat-releasable material is configured and/or designed such that the heat releasable material is solid at normal environmental temperatures, and which dissolves, melts, disintegrates, degrades, and/or evaporates upon artificial heating above normal environmental temperatures, such that artificial heating results in removal or detachment of the identification element from the livestock animal.

In yet another embodiment of any of the above identification element or identification elements, the polymer material or resin may preferably comprise a polyvinyl alcohol-based resin.

In another embodiment of any of the above identification element or identification elements, the heat-releasable material may comprise a solid polymer material or resin which dissolves or melts upon artificial heating by exposure to a heated liquid or gas.

In still another embodiment of any of the above identification element or identification elements, the heated liquid or gas may comprise heated water or steam, or another water-based or non-water based solution, liquid, gas, or fluid.

In yet another embodiment of any of the above identification element or identification elements, the heat-releasable material may comprise a polyvinyl alcohol-based resin which is water insoluble at normal environmental temperatures, and which is water soluble (e.g. dissolves) upon heating above normal environmental temperatures.

In another embodiment of any of the above identification element or identification elements, the polyvinyl alcohol-based resin may be water soluble upon artificial heating above a temperature of at least about 50° C.

In still another embodiment of any of the above identification element or identification elements, the polyvinyl alcohol-based resin may be water soluble upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more.

In yet another embodiment of any of the above identification element or identification elements, the heat-releasable material may comprise a polyvinyl alcohol-based material which is substantially insoluble in water at temperatures up to at least about 40° C., and which becomes water soluble at a temperature no less than about 50° C.

In another embodiment of any of the above identification element or identification elements, the heat-releasable material may comprise a Hydropol™ polymer.

In still another embodiment of any of the above identification element or identification elements, the heat-releasable material may comprise Hydropol™ 30124, 30163, 30164, or 33104.

In yet another embodiment of any of the above identification element or identification elements, the identification element may be in the form of a tag, band, bracelet, collar, spring, or clip.

In another embodiment of any of the above identification element or identification elements, the attachment fitting may comprise a rivet, snap, hook, tie, loop, strap, hinge, clip, pin, spring, latch, or other friction fit or fastening mechanism for securing the identification element to the livestock animal or article requiring cleaning and/or disinfecting, wherein heating the heat-releasable material disengages or destroys the fastening mechanism, thereby removing or detaching the identification element from the livestock animal. In certain embodiments, the attachment fitting may also encompass an attachment portion of a tape or label-type tag, and/or the adhesive thereof used to secure the tape or label-type tag together.

In still another embodiment of any of the above identification element or identification elements, all or substantially all of the attachment fitting may be formed of the heat-releasable material.

In yet another embodiment of any of the above identification element or identification elements, the unique identifier element may comprise a label, barcode, RFID identifier, or any combination thereof.

In another embodiment of any of the above identification element or identification elements, the unique identifier element may comprise a label and/or barcode providing identifying details for the livestock animal readable visually, electronically, or both.

In still another embodiment of any of the above identification element or identification elements, the unique identifier element may be fabricated of a material that dissolves, melts, disintegrates, degrades, and/or evaporates upon artificial heating; or the unique identifier element may be resistant to artificial heating and may be recoverable following removal or detachment of the identification element from the livestock animal.

In another embodiment, there is provided herein a use of any of the identification element or identification elements as described herein for identifying and/or tracking a livestock animal.

In still another embodiment of the above use, the identification element may be for removal or detachment from the livestock animal prior to or during production of meat from the animal, by exposing the identification element to artificial heating.

In yet another embodiment of any of the above use or uses, the identification element may be removable or detachable from the livestock animal during a scalding or flame-based hair removal stage of a meat production process.

In another embodiment, there is provided herein a method for identifying and/or tracking a livestock animal, said method comprising:
securing any of the identification element or identification elements as described herein to the livestock animal;
using the identification element to uniquely identify and/or track the livestock animal over a period of time; and
removing or detaching the identification element from the livestock animal prior to or during production of meat from the animal.

In still another embodiment of the above method, the step of removing or detaching may comprise exposing the identification element to artificial heating.

In yet another embodiment of any of the above method or methods, the step of removing or detaching may comprise a scalding or flame-based hair removal stage of a meat production process.

In yet another embodiment, there is provided herein an identification element comprising:
an attachment fitting for securing the identification element to a subject or article of interest; and
a unique identifier element affixed to, integrated with, or embedded in the attachment fitting;
at least a portion of the attachment fitting being formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the subject or article of interest.

In another embodiment of the above identification element, the heat-releasable material may dissolve, melt, disintegrate, degrade, and/or evaporate upon artificial heating above a temperature of at least about 50° C.

In still another embodiment of any of the above identification element or identification elements, the heat-releasable material may dissolve, melt, disintegrate, degrade, and/or evaporate upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more.

In yet another embodiment of any of the above identification element or identification elements, the heat-releasable material may completely dissolve, melt, disintegrate, degrade, and/or evaporate upon artificial heating for about 1 hour or less.

In another embodiment of any of the above identification element or identification elements, the heat-releasable material may completely dissolve, melt, disintegrate, degrade, and/or evaporate upon artificial heating for 10 minutes, 9 minutes, 8 minutes, 7 minutes, 6 minutes, 5 minutes, 4 minutes, 3 minutes, 2 minutes, or less.

In still another embodiment of any of the above identification element or identification elements, the heat-releasable material may comprise a polymer material or resin.

In still another embodiment of any of the above identification element or identification elements, the heat-releasable material, polymer material, or resin may comprise one or more of a polyvinyl alcohol; an alkali-soluble resin; cellulose; a cellulose chemical derivative; a hydrophilic polymer; carboxymethyl cellulose; hydroxyethyl cellulose; Polyox; alginate; polyacrylamide; poly(acrylic acid); poly(methacrylic acid); polyethylene oxide; a starch; or a gelatin; or any combinations thereof; wherein the heat-releasable material is configured and/or designed such that the heat releasable material is solid at normal environmental temperatures, and which dissolves, melts, disintegrates, degrades, and/or evaporates upon artificial heating above normal environmental temperatures, such that artificial heating results in removal or detachment of the identification element from the subject or article of interest.

In yet another embodiment of any of the above identification element or identification elements, the polymer material or resin may comprise a polyvinyl alcohol-based resin.

In another embodiment of any of the above identification element or identification elements, the heat-releasable material may comprise a solid polymer material or resin which dissolves or melts upon artificial heating by exposure to a heated liquid or gas.

In still another embodiment of any of the above identification element or identification elements, the heated liquid or gas may comprise heated water or steam.

In yet another embodiment of any of the above identification element or identification elements, the heat-releasable material may comprise a polyvinyl alcohol-based resin which is water insoluble at normal environmental temperatures, and which is water soluble upon heating above normal environmental temperatures.

In another embodiment of any of the above identification element or identification elements, the polyvinyl alcohol-based resin may be water soluble upon artificial heating above a temperature of at least about 50° C.

In still another embodiment of any of the above identification element or identification elements, the polyvinyl alcohol-based resin may be water soluble upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, or higher, 76° C. or higher, 77° C. or higher, 78° C. or higher, 79° C. or higher, or 80° C. or higher, or more.

In yet another embodiment of any of the above identification element or identification elements, the heat-releasable material may comprise a polyvinyl alcohol-based material which is substantially insoluble in water at temperatures up to at least about 40° C., and which becomes water soluble at a temperature no less than about 50° C.

In another embodiment of any of the above identification element or identification elements, the heat-releasable material may comprise a Hydropol™ polymer.

In still another embodiment of any of the above identification element or identification elements, the heat-releasable material may comprise Hydropol™ 30124, 30163, 30164, or 33104.

In yet another embodiment of any of the above identification element or identification elements, the identification element may be in the form of a tag, band, bracelet, collar, spring, or clip.

In another embodiment of any of the above identification element or identification elements, the attachment fitting may comprise a rivet, snap, hook, tie, loop, strap, hinge, clip, pin, spring, latch, or other friction fit or fastening mechanism for securing the identification element to the subject or article of interest, wherein heating the heat-releasable material disengages or destroys the fastening mechanism, thereby removing or detaching the identification element from the subject or article of interest. In further embodiments, the attachment fitting may also encompass an attachment portion of a tape or label-type tag, and/or the adhesive thereof used to secure the tape or label-type tag together.

In still another embodiment of any of the above identification element or identification elements, all or substantially all of the attachment fitting may be formed of the heat-releasable material.

In yet another embodiment of any of the above identification element or identification elements, the unique identifier element may comprise a label, barcode, RFID identifier, or any combination thereof.

In another embodiment of any of the above identification element or identification elements, the unique identifier element may comprise a label and/or barcode providing identifying detail(s) for the subject or article of interest that is/are readable visually, electronically, or both.

In still another embodiment of any of the above identification element or identification elements, the unique identifier element may be fabricated of a material that dissolves, melts, disintegrates, degrades, and/or evaporates upon artificial heating; or the unique identifier element may be resistant to artificial heating and may be recoverable following removal or detachment of the identification element from the subject or article of interest.

In another embodiment, there is provided herein a use of any of the identification element or identification elements as described herein for identifying and/or tracking a subject or article of interest.

In another embodiment, there is provided herein a method for identifying and/or tracking a subject or article of interest, said method comprising:
securing any of the identification element or identification elements as described herein to the subject or article of interest;
using the identification element to uniquely identify and/or track the subject or article of interest over a period of time; and
removing or detaching the identification element from the subject or article of interest by artificially heating the identification element.

In another embodiment of the above method, the step of removing or detaching the identification element may comprise exposing the identification element to hot water or steam.

In yet another embodiment, there is provided herein an identification element for livestock or another subject or article of interest, comprising:
an attachment fitting for securing the identification element to a livestock animal or other subject or article of interest; and
a unique identifier element affixed to, integrated with, or embedded in the attachment fitting;
wherein the attachment fitting remains secured to the livestock animal or other subject or article of interest under normal environmental temperatures, and wherein the attachment fitting is heat-releasable such that artificial heating above normal environmental temperatures results in removal or detachment of the identification element from the livestock animal or other subject or article of interest.

In another embodiment of any of the above identification element or identification elements, the identification element may be an implantable identification element.

In another embodiment, there is provided herein a method for identifying and/or tracking a livestock animal or other subject or article of interest, said method comprising:
securing an identification element to the livestock animal or other subject or article of interest, the identification element comprising an attachment fitting for securing the identification element to the livestock animal or other subject or article of interest, and a unique identifier element affixed to, integrated with, or embedded in the attachment fitting, wherein at least a portion of the attachment fitting is formed of a heat-releasable material which is solid at normal environmental temperatures, and which dissolves, melts, disintegrates, degrades, and/or evaporates upon artificial heating above normal environmental temperatures;
using the identification element to uniquely identify and/or track the livestock animal or subject or article of interest over a period of time; and
removing or detaching the identification element from the subject or article of interest by artificially heating the identification element such that the artificial heating results in removal or detachment of the identification element from the livestock animal or other subject or article of interest.

In another embodiment, there is provided herein an implantable identification element for livestock or another subject or article of interest, comprising:
a housing; and
a unique identifier element affixed or joined to, integrated with, housed within, or embedded in the housing;
at least a portion of the housing being formed of a heat-releasable material which is solid at normal environmental temperatures, and which dissolves, melts, disintegrates, degrades, and/or evaporates upon artificial heating above normal environmental temperatures, such that artificial heating results in removal of the identification element from the livestock animal/subject/article of interest, destruction of the identification element, or both.

In still another embodiment, there is provided herein an identification element for a livestock animal or other subject or article of interest, the identification element comprising:
a unique identifier element; and
an outer protective barrier encompassing at least a portion of the unique identifier element, the outer protective barrier comprising at least one of: a film-type outer coating or layer; an outer sleeve or casing; or another outer coating, film, casing, or enclosure;
at least a portion of the outer protective barrier being heat-releasable, such that the outer protective barrier remains intact and provides protection of the unique identifier element under normal environmental temperatures, and releases or exposes the unique identifier element when subjected to artificial heating.

In yet another embodiment of the above identification element, at least a portion of the outer protective barrier may comprise or may be formed of a heat-releasable material which is solid at normal environmental temperatures, and which dissolves, melts, disintegrates, degrades, and/or evaporates upon artificial heating above normal environmental temperatures.

### BRIEF DESCRIPTION OF DRAWINGS

These and other features will become further understood having regard to the following drawings in which:

FIG. 1 shows an illustrative example of an ear tag-type identification element as described herein;

FIG. 2 shows another illustrative example of an ear tag-type identification element as described herein;

FIG. 3 shows an illustrative example of a tail tag-type identification element as described herein, in top (A), side (B), and isometric (C) views;

FIG. 4 shows an illustrative example of leg bracelet-type identification element as described herein;

FIG. 5 shows results of testing of heat-releasable materials under artificial heating conditions as described in Example 2 below. A variety of Hydropol™ materials were tested, and this Figure shows results for dissolution time as a function of temperature, for 95% dissolution;

FIG. 6 shows results of testing of heat-releasable materials under artificial heating conditions as described in Example 2 below. A variety of Hydropol™ materials were tested, and this Figure shows results for dissolution time as a function of temperature, for 50% dissolution;

FIG. 7 shows (A) an exploded view of an example of an ear tag-type identification element as shown in FIG. 1, illustrating an embodiment in which an RFID chip or similar device is positioned within an injection molded identification element housing; (B) an exploded view of an example of an ear tag-type identification element as shown in FIG. 1, illustrating an embodiment in which a printed crystalline bar code, QR code or similar printed tracking element is positioned within layers of an identification element as described herein;

FIG. 8 shows a cross-sectional view of an example of an implantable identification element, in which an RFID chip or similar device is positioned within a heat activated dissolvable implant material;

FIG. 9 illustrates an example of an embodiment of the invention in which a tape or label style identification element is applied to an animal. As shown in (A) of this example, the tape or label style identification element is applied to the leg of a chick using a tape/label dispenser. (B) shows the chick after removing the chick's leg from the tape/label dispenser, with the identification element securely affixed, and (C) shows a magnified view of the identification element secured to the chick's leg;

FIG. 10 illustrates a further example of the tape or label style identification element shown in FIG. 9, applied to a surgical knife marked for disinfecting after use;

FIG. 11 illustrates another example of the tape or label style identification element shown in FIG. 9, applied to the drawstring of a laundry bag marked for cleaning and/or pickup.

### DETAILED DESCRIPTION

Described herein are identification elements, and methods and uses thereof for identification and/or tracking of subject(s) or article(s) of interest, such as (but not limited to) livestock animals for meat production. It will be appreciated that embodiments and examples are provided for illustrative purposes intended for those skilled in the art, and are not meant to be limiting in any way.

Food traceability, particularly for the purposes of safety, recall and consumer awareness of the source/origins of their food, as well as for tracking livestock health as it pertains to the spread of diseases such as Swine Flu and Porcine Epidemic Diarrhea, are examples highlighting the desirability of identifying and tracing livestock from genetics, birth through to processing, and delivery to the end customer. Effective tracking and identification technologies for any or all of these stages is highly sought after in the field, especially those able to withstand the rigours of livestock production throughout the life of the animal, without negatively impacting production costs or food quality. Typically, producers would bear the cost for tracking and identification devices; however, the meat packers would typically be expected to bear the cost of removing these devices during the meat preparation and/or packing processes, creating challenges. Effective devices and methods for tracking livestock animals until they reach the meat processing facility, but without placing the laborious burden of device removal and disposal on the processing facility, would be a welcome development in the field.

The methods of tagging and/or marking livestock described herein, and associated devices, break down key barriers that exist in the industry today which prevent further advancement of traceability that can improve food safety, animal productivity, disease control and biosecurity. By lowering costs and lessening the burden on producers and processors, embodiments of the described technology can enable advancements in per unit/animal level traceability, allowing the data analytics to be leveraged for improvements across global animal protein production industries. Data is becoming increasing important for optimizing production and performance, and reducing the resources required to produce animal protein. By providing a cost effective way to identify each individual animal, a major industry barrier is removed between producers and processors, thus opening up doors to new levels of efficiency and safety in livestock production.

Provided herein are identification and tracking devices that are attachable to an article or subject of interest, typically a livestock animal, that are long-lasting and remain intact under normal environmental conditions, but which are easily removable through artificial application of heat, typically in the form of hot water, steam, or flame. Devices as described herein may remain intact under the regular conditions to which the article or subject is exposed during a period for which identification and/or tracking is desired, and yet be removable or detachable from the article or subject by artificial heat treatment exceeding the temperatures/conditions that the article or subject normally encounters. By way of example, for identification and/or tracking of livestock animals for meat production, the devices described herein may be configured to remain intact under the conditions which the animal experiences on the farm (which, depending on the farm, the animal, and the climate, may include outdoor environmental conditions that may include hot and/or cold days, dry and/or wet/rainy days; indoor barn, coop, or shelter conditions; or combinations thereof; and may involve exposure to moisture, humidity, and/or abrasion), and to resist damage from mechanic stresses and wear-and-tear while attached to the animal. Then, when the time comes for meat production, the devices as described herein may be configured to be automatically removable or detachable from the animal carcass during scalding or flame-based hair removal stage(s) (which artificially impart heat, typically in the form of hot water, steam, or flame) that are already part of many conventional meat processing operations, without requiring additional removal steps or manipulations from the farmer or meat production workers. Alternatively, another artificial heat treatment performed before, during, or after the meat production process may remove or detach the identification element, and the artificial heat treatment may already be part of an existing meat production process, may be performed for any of a variety of different reasons and concurrently also remove or detach the identification element, or may be performed specifically to remove the identification element.

By way of another example, meat processing facilities often have singing equipment, in the form of flame filled cabinets used to singe hair off of the animal carcass. Such flame signing may provide the artificial heating, resulting in removal of the identification element by melting of the heat-releasable material. In certain embodiments, the heat-releasable material may be designed to melt without leaving a residue (or to evaporate, for example) to even further reduce risk of contamination of the resultant food. Many other food processing operations and processes may also impart heat, thereby providing the artificial heating for removal or detachment.

The identification and/or tracking devices described herein comprise a unique identifier element, and an attachment fitting for securing the identification element to the article or subject of interest, wherein at least a portion of the attachment fitting is formed of a heat-releasable material which is solid at normal environmental temperatures and conditions, but which dissolves, melts, disintegrates, degrades, and/or evaporates upon artificial heating above normal environmental temperatures, such that heating results in removal or detachment of the identification element from the article or subject of interest.

In the meat production industry, for example, it is contemplated that such identification elements as described herein may be used for identification and/or tracking (e.g. marking) of livestock. In order to prepare meat from the livestock animal, the carcass is often subjected to a scalding or flame-based hair removal stage as part of routine meat processing. For processing of pigs (pork), for example, a scalding process is often employed for dehairing which submerges the carcass in water at a temperature of around 50-70° C. for about 5-10 minutes to loosen the hair in the follicles. Identification elements as described herein may be configured to be removed or detached from the carcass during such scalding or flame-based processing (which impart artificial heating) without requiring direct manipulation by the farmer or meat production worker, thereby avoiding a laborious removal step that is performed for conventional tags and reducing risk of tags inadvertently contaminating meat products due to forgotten tags. Identification elements as described herein may be formed, in whole or in part, of a heat-releasable material. In some examples, the identification element may be fully dissolved, melted, disintegrated, degraded, and/or evaporated upon artificial heating, simplifying clean-up and disposal of removed identification elements. In other examples, at least part of the identification element (such as the unique identifier element, for example) may remain intact following artificial heating, such that it can be recovered and reused.

It is additionally contemplated that identification elements as described herein may be configured and used for any of a wide variety of applications, and may be used to identify and/or track a wide variety of different articles or subjects. By way of example, it is contemplated that identification elements as described herein may be used for identification and/or tracking of articles or batches of clothing or other such materials to be laundered or sanitized. In such applications, it is contemplated that the burdensome step of removing conventional labels/tags from articles of clothing prior to cleaning in a washing machine can be avoided, as the identification elements as described herein may be configured to automatically remove or detach upon exposure to the hot water conditions in the clothes washing machine, for example.

In preferred embodiments, identification elements as described herein may be used for identification and/or tracking of livestock animals intended for meat production, and may be configured so as to be automatically/passively removed during one or more normally performed meat preparation or meat processing stages involving artificial heating, without requiring direct manipulation of the identification element by the farmer or meat processing worker.

In an embodiment, there is provided herein an identification element for livestock, comprising:
an attachment fitting for securing the identification element to a livestock animal; and
a unique identifier element affixed to, integrated with, or embedded in the attachment fitting;
at least a portion of the attachment fitting being formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal.

In certain embodiments, the identification element may have any suitable size, shape, and form suitable for the particular application. For example, the identification element may be sized appropriately such that it is not obtrusive to the animal, and does not catch or snag as the animal moves around. By way of example, in certain preferred embodiments the identification element may be in the form of a tag, band, bracelet, collar, spring, or clip. Tags are commonly used for livestock identification, and examples include ear tags that are commonly installed via ear piercing of the animal. Bands, bracelets, and collars may include elastic bands, straps, Velcro loops, rings, tied or knotted linkages, hinged sections closable with a latch or other linking mechanism, zip ties, or other such forms that encompass or encircle a part of the animal for fastening, such as a section of the animal's leg or neck for example. Bands, bracelets, and collars may typically be installed on the animal at a narrowed part of the body to prevent detachment (e.g. installation at the neck prevents detachment as the head and mid-section are typically both wider than the neck). Springs may include any suitable coil-type structure that can be securely installed on the animal, such as coil-type structures that can be twisted or fitted onto the animal's tail. Bands, bracelets, collars, and/or springs may also include aperture-type structures where a part of the animal is pulled through the aperture (for example, the tail), and held there via friction-fit. Clips may include pinching or tensioned (for example, spring tensioned) structures that can be clipped or fastened to the animal, often at the ear or tail (for example).

In certain embodiments, the livestock animal may be any relevant animal for which tracking and/or identification is desired. By way of example, in certain embodiments, the livestock animal may comprise a pig (swine), cattle (beef), lamb, or poultry (i.e. chicken or turkey) animal. In preferred embodiments, the livestock animal is an animal intended for meat production, where meat production processing steps include at least one stage involving artificial heating. Examples of artificial heating in meat processing may including, for example, scalding and/or flame processes commonly performed for hair removal.

The attachment fitting may comprise any suitable structure or mechanism for securing the identification element to the livestock animal. By way of example, in certain embodiments the attachment fitting may comprise a rivet, snap, hook, tie (for example knotted or tied linkages), loop (for example, an elastic band, Velcro loop, zip tie, ring, other such form that encompasses or encircles a part of the animal for fastening, etc. . . . ), strap, hinge (for example, hinged sections closable with a latch, pin, or other linking mechanism), clip (for example, pinching or tensioned (such as spring-tensioned) structures that can be clipped or fastened to the animal), pin, spring (for example, coil-type structures that can be securely installed on the animal, such as coil-type structures that can be fitted or twisted onto the tail of the animal), latch, or other friction fit (for example, aperture-type friction-fit in which a part of the animal is pulled through the aperture and held there via friction fit) or fastening mechanism for securing the identification element to the livestock animal. Where the identification element is an ear tag, for example, the attachment fitting may in certain embodiments comprise a male portion on a first side of the ear and extending through a piercing in the ear, and a co-operating female receiving portion on a second side of the ear receiving and securely engaging (often via friction fit) a section of the male portion that extends through the ear piercing. The male portion may include a widened section toward a first end which, once received by the female receiving portion, prevents removal of the male portion from the female receiving portion. As will be understood, such male/female co-operating designs are not limited to ear tags, and may be used in a variety of different identification element designs. In further embodiments, the attachment fitting may also encompass an attachment portion of a tape or label-type tag, and/or the adhesive thereof used to secure the tape or label-type tag together.

The unique identifier element may comprise any suitable identifier element capable of uniquely identifying the livestock animal and differentiating the livestock animal from other animals. The person of skill in the art having regard to the teachings herein will be aware of a variety of different identifier element designs that may be used alone or in combination, which may include simple written, typed, inked, or stamped unique identification codes, names, or labels, as well as more sophisticated or electronically detectable or readable unique labels such as barcodes, Bluetooth tags, radio-frequency identification (RFID) devices, tags, or transponders, or any other suitable identifier element known to the person of skill in the art having regard to the teachings herein. In certain embodiments, the unique identifier element may comprise an embedded or inserted (or embeddable or insertable) microchip(s) or other device(s) providing for uniquely identifiable tracking. In certain embodiments, the unique identifier element may comprise a GPS unit allowing location identification and tracking. In certain embodiments, the unique identifier element may comprise a label, barcode, RFID identifier, or any combinations thereof. In certain embodiments, the unique identifier element may comprise a label and/or barcode providing identifying details for the livestock animal readable visually, electronically, or both. In certain embodiments, the unique identifier element may comprise any suitable identifier element capable of providing a unique visual signature or other signature, recognizable or readable by eye, electronically (for example, by barcode scanner, camera, spectrometry, etc. . . . ), by other means, or any combinations thereof. In certain embodiments, the unique identifier element may comprise any suitable unique identifier element capable of being identified/differentiated by photo recognition, light recognition, or other such technique. In certain embodiments, the unique identifier element may comprise a paper or sticker or other material displaying a unique identifier or number or code or barcode, or the unique identifier element may comprise a unique identifier or number or code or barcode printed or formed directly on a surface of the attachment fitting or another region of the identification element. In certain embodiments, the unique identifier element may (or may not) optionally be partially or fully fabricated of a water soluble material. Examples of unique identifier elements that are commercially available may include those available from AllFlex (https://www.allflex.global/na/).

As will be understood, in certain embodiments the unique identifier element may be affixed to, integrated with, or embedded in the attachment fitting of the identification element. As described herein, the attachment fitting provides for securing of the identification element to the livestock animal (or other subject or article of interest), and the unique identifier element may be directly or indirectly associated with the attachment fitting such that unique identifier element (and/or the identification element of which the unique identifier element is a part of) remains securely attached to the livestock animal (or other subject or article of interest) due to function of the attachment fitting. In certain embodiments, the unique identifier element may be directly or indirectly affixed to the attachment fitting, for example by being glued, taped, tied, fused, bound, linked, or otherwise directly or indirectly joined to the attachment fitting. The unique identifier element may be directly affixed to the attachment fitting, or may be provided at another region or portion of the identification element which is associated with the attachment fitting, and thus indirectly affixed to the attachment fitting. In certain embodiments, the unique identifier element may be integrated with the attachment fitting, for example in certain embodiments the unique identifier element may be written, stamped, inked, imprinted, or otherwise formed or provided directly on a portion of the attachment fitting. By way of example, in certain embodiments a barcode may be directly inked, stamped, imprinted, molded, or etched onto a surface of a portion of the attachment fitting. In certain embodiments, the unique identifier element may be embedded in the attachment fitting. By way of example, in certain embodiments, the attachment fitting may comprise a body portion, or may be joined or connected with a body portion, in which the unique identifier element (such as an RFID or Bluetooth tag, for example) may be embedded via a molding or forming process, or the body portion may comprise a pocket or housing into which the unique identifier element may be securely placed.

In certain embodiments, the attachment fitting may include or may be directly or indirectly linked or joined with a body portion for holding, securing, housing, displaying, presenting, and/or accommodating the unique identifier element. For example, in an ear tag-type design, the attachment fitting may comprise male and female co-operating elements as described above for securing to an ear of an animal at an ear piercing, and the attachment fitting may further comprise a body portion extending from the male/female co-operating element attachment site, the body portion configured to accommodate the unique identifier element. For example, where the unique identifier element is a written number or label or barcode, the number or label or barcode may be directly written, printed, stamped, inked, molded or formed on a surface of the body portion, or the written number or label or barcode may be provided on a piece of paper or sticker or other material, which may be glued, taped, or otherwise affixed to a surface of the body portion, or may be inserted into a pocket or housing formed in the body portion for accommodating the unique identifier element. In embodiments using an RFID or Bluetooth tag or GPS (global positioning system) unit as identifier element, the RFID or Bluetooth tag or GPS unit may be glued, taped, or otherwise affixed to the body portion, or the body portion may comprise a pocket or housing for accommodating the RFID or Bluetooth tag or GPS unit, or the RFID or Bluetooth tag or GPS unit may be embedded, molded, or formed within the body portion, for example. As will be understood, many different configurations of the attachment fitting and unique identifier element may be possible, and these embodiments and examples are provided for illustrative purposes, additional designs and configurations are also contemplated.

In certain embodiments, the heat-releasable material or component of the attachment fitting may comprise any suitable material that suitably changes (for example, by changing in state, softening, becoming destroyed, dispersing, or otherwise changing or evolving chemically and/or physically, etc. . . . ) upon exposure to artificial heating, so as to allow for the removal, separation, destruction, or combinations thereof, of the identifying element from the livestock animal, subject, or article of interest.

In certain embodiments as described herein, at least a portion of the attachment fitting of the identification element is formed of a heat-releasable material, which is solid at normal environmental temperatures, and which dissolves, melts, disintegrates, degrades, and/or evaporates upon artificial heating above normal environmental temperatures, such that artificial heating results in removal or detachment of the identification element from the livestock animal. In certain embodiments, all or substantially all of the attachment fitting may be formed of the heat-releasable material such that artificial heating results in removal of the identification element from the livestock animal; or, only a portion of the attachment fitting may be formed of the heat-releasable material, the portion being a key portion which, upon failure due to artificial heating, results in failure of the attachment fitting leading to detachment of the identification element from the livestock animal. As will be understood, a key portion, or failure portion, may be selected to suit the particular type of attachment fitting being using. Where the attachment fitting comprises a band or ring, for example, generally any section around the loop of the band or ring may be formed of the heat-releasable material such that artificial heating breaks the loop, resulting in detachment of the band or ring. Where the attachment fitting comprises male and female co-operating elements, one or both of the co-operating elements (or a portion thereof, such as a widened end of the male portion responsible for securing the male and female co-operating elements together) may be formed of the heat-releasable material such that artificial heating results in failure of the co-operating elements and detachment of from the livestock animal. In certain embodiments, the attachment fitting may comprise a pin or latch mechanism, wherein the pin or latch may shrink in size upon artificial heating, allowing for the identification element to release or separate from the livestock animal, subject, or article of interest. The skilled person having regard to the teachings herein will be aware of key portion(s) of various attachment fitting mechanisms suitable to be formed of the heat-releasable material such that heating the heat-releasable material disengages or destroys the fastening mechanism, thereby detaching the identification element from the livestock animal.

In still another embodiment of any of the above identification element or identification elements, all or substantially all of the attachment fitting may be formed of the heat-releasable material, such that artificial heating results in removal of the attachment fitting such that there is no need for recovery and disposal of the attachment fitting, simplifying clean-up. Where the unique identifier element is integrated with the attachment fitting, or also formed of the same or a different heat-releasable material, it is contemplated that in certain embodiments artificial heating may result in removal of the entire identification element (or most of the identification element) such that there is no need for recovery and disposal of the identification element, simplifying clean-up.

In other embodiments, it is contemplated that the unique identifier element may be configured (through choice of fabrication materials, insulation, an outer protective covering, etc . . . , for example) so as to resist the artificial heating, such that the unique identifier element can be recovered following the artificial heating and reused in a new identification element, being re-assigned to a new livestock animal or another subject or article of interest. Such recovery may be desirable in certain applications, such as those where, for example, a relatively expensive or sophisticated unique identifier element, such as a Bluetooth tag, is used.

As will be understood, a heat-releasable material may comprises generally any suitable material which is generally structurally stable (e.g. sufficiently solid and intact) under normal environmental temperatures and conditions to which the livestock animal (or other subject or article of interest) will normally be exposed during the period of time for which tracking and/or identification is desired, and which becomes structurally unstable (through a dissolution, melting, disintegration, degradation, and/or evaporation process, or any combinations thereof) upon experiencing artificial heating to temperatures above those normal environmental temperatures and conditions. As will be understood, dissolution, melting, disintegration, degradation, and/or evaporation of the heat-releasable material may include generally any change or evolution of the heat-releasable material such that artificial heating results in removal or detachment of the identification element from the livestock animal, subject, or article of interest. As will be understood, dissolution, melting, disintegration, degradation, and/or evaporation of the heat-releasable material may encompass many different physical and/or chemical changes of the heat-releasable material. The person of skill in the art having regard to the teachings herein will understand the various types of physical and/or chemical changes that may be involved with dissolution, melting, disintegration, degradation, and/or evaporation of the heat-releasable material, which may differ depending on the heat-releasable material used and/or the artificial heating applied.

Typically, normal environmental temperatures and conditions will include normal outdoor weather conditions to which the animal is exposed (which may include, depending on climate and the type of animal, cooler and warmer temperatures, sunshine and rainy conditions), and/or normal indoor weather conditions to which the animal is exposed (which may include, depending on the animal, normal indoor barn or pen conditions). Typically, the heat-releasable material may be selected and/or configured to suit the particular application and normal environmental temperatures and conditions to which the livestock animal (or subject or article of interest) is expected to experience, such that the heat-releasable material remains structurally stable under these normal temperatures and conditions, so that the identification element remains secured to the livestock animal (or subject or article of interest) throughout the period of time for which tracking and/or identification is desired. In preferred embodiments, the heat-releasable material may be selected and/or configured to remain structurally stable to a temperature of at least about above the temperatures the livestock animal (or subject or article of interest) is expected to experience, as a safety buffer, although this safety buffer may be more or less, and may be tailored to the particular application(s) of interest.

In embodiments as described herein, the heat-releasable material is selected and/or configured to become structurally unstable upon experiencing artificial heating to temperatures above the normal environmental temperatures and conditions to which the livestock animal (or subject or article of interest) is exposed during the period for which identification and/or tracking is desired. The heat-releasable material is selected and/or configured such that this artificial heating creates conditions under which the heat-releasable material becomes structurally unstable by dissolution, melting, disintegration, degradation, and/or evaporation, or any combinations thereof, of all or a portion of the heat-releaseable material, such that artificial heating results in removal or detachment of the identification element from the livestock animal (or subject or article of interest).

As will be understood, the artificial heating may be any heating or heat-based treatment applied which elevates the temperature above the normal environmental temperatures and conditions to which the livestock animal (or subject or article of interest) is exposed during the period for which identification and/or tracking is desired. The artificial heating may, for example, arise from heating of the ambient air to which the animal or carcass is exposed, through flame treatment of the carcass, or from application of heated water, steam, or another heated fluid, for example. The artificial heating may be applied deliberately for the purpose of removing or detaching the identification element, or may be applied as part of another process or treatment (such as hair removal and/or sterilization) and may beneficially also result in removal or detachment of the identification element. Typically, artificial heating may involve applying heated water (which may include heated water-based solutions containing one or more additional components) or steam, often at temperatures of around 50-70° C. or more. Scalding processes for hair removal, for example, commonly involve artificial heating by submerging the carcass in hot water at around 50-70° C. (typically 60-63° C.) for several minutes. Sterilization processes may also involve artificial heating to temperature of about 50-70° C., or more. In the example of clothing as the article of interest, artificial heating may be applied in the form of hot water in a clothes washing machine, for example.

In preferred embodiments, particularly where tracking and/or identification of livestock animals intended for meat production is desired, it is contemplated that the artificial heating may be applied as part of a scalding or flame-based hair removal process often performed as part of regular meat production steps, whereby the identification element (and the heat-releasable material thereof) is exposed to artificial heating in the form of hot water or steam (for scalding) or flame (for flame-based hair removal). In the case of hot water or steam scalding, the heat-releasable material may preferably be selected so as to melt, dissolve, or both, upon exposure to the hot water or steam (or heat therefrom), such that the heat-releasable material loses structural stability, resulting in removal or detachment of the identification element from the livestock animal.

In certain embodiments, it is contemplated that the heat-releasable material may be selected and/or configured to dissolve, melt, disintegrate, degrade, and/or evaporate upon artificial heating by appropriate selection of the heat-releasable material. The person of skill in the art having regard to the teachings herein will be aware of a variety of different materials that may be selected as heat-releasable material, based on a differential ability of the material to remain structurally intact under the normal environmental temperatures and conditions to which the livestock animal (or subject or article of interest) is exposed during the period for which identification and/or tracking is desired, and to become structurally unstable upon artificial heating, as part of the particular application of interest. In certain embodiments, the heat-releasable material may comprise a polymer material or resin. By way of example, a variety of polymer and resin-based materials are commercially available which provide for melting and/or dissolution upon heating to temperatures above regular indoor and outdoor ambient temperatures. Examples of polymer or resin-based heat releasable materials may include polyvinyl alcohol-based polymers and/or resins (including those polyvinyl alcohol-based polymers, resins, plastics, and other such materials in which hydrolysis and/or molecular weight may be controlled/tailored to provide desired property/properties such as water solubility/temperature profiles), such as (but not limited to) the commercially available Hydropol™ materials (available from Aquapak Polymers, technical details of which can be found at www.aquapakpolymers.com, and are herein incorporated by reference), among others. Other polyvinyl alcohol-based hot water soluble resin blends are described in U.S. Pat. No. 5,658,977 (which relates to films and fabrics, such as hospital fabrics, sheets and garments to be disinfected and/or disposed of). In certain embodiments, the heat-releasable material may comprise an injection-moldable plastic, polymer, or resin to assist with fabrication, such as polyvinyl alcohol (PVOH)-based materials optionally blended with one or more other plastics, polymers, or resins. In certain embodiments, additional examples of heat-releasable materials that are contemplated may include one or more of those commercially available from Mitsubishi Chemical company, such as the commercially available Hi-Selon products which are PVOH-based dissolving materials (https://www.m-chemical.cajp/en/products/departments/mcc/acetyl/product/1205876_9064.html); from Soltec (https://www.soltec-development.com/en/); from EP GPLC (www.epgplc.com); as described by Plastics Today (https://www.plasticstoday.com/water-solumble-polymer-makes-its-debut); and/or from Aquapak Polymers (https://www.aquapakpolymers.com/); or other such materials, for example.

In certain embodiments, the identification elements, or the attachment fittings thereof, as described herein may be fabricated using an injection moulding process, or a film extrusion process, for example.

In preferred embodiments, the heat-releasable material may comprise a polyvinyl alcohol-based resin formulation tailored to provide a desired solubility temperature suitable for the particular application of interest and conditions thereof (both the normal conditions, and the artificial heating conditions). In certain other embodiments, it is contemplated that other materials may be utilized such as water soluble paper-based or cellulose-based products, materials coated with a water-soluble resin, or other materials that remain in a physical solid state in barn or other livestock production conditions, while breaking down in an artificial heating process such as a stream or submersion scalding process at a processing facility.

In certain embodiments, the heat-releasable material, polymer material, or resin may comprise one or more of a polyvinyl alcohol (such as a polyvinyl alcohol based resin or polymer); an alkali-soluble resin; cellulose; a cellulose chemical derivative; a hydrophilic polymer; carboxymethyl cellulose; hydroxyethyl cellulose; Polyox; alginate; polyacrylamide; poly(acrylic acid); poly(methacrylic acid); polyethylene oxide; a starch; or a gelatin; or any combinations thereof; wherein the heat-releasable material is configured and/or designed such that the heat releasable material is solid at normal environmental temperatures, and which dissolves, melts, disintegrates, degrades, and/or evaporates upon artificial heating above normal environmental temperatures, such that artificial heating results in removal or detachment of the identification element from the livestock animal, subject, or article of interest. As will be understood, the heat-releasable material may be tailored or selected to suit the particular application(s) of interest and conditions thereof.

Additional examples and/or discussions relating to certain heat-releasable materials, polymer materials, and/or resins (including water-soluble materials), and/or formulation thereof, may be found in “The Complete Book on Water Soluble Polymers” (by NPCS Board of Consultants & Engineers, Asia Pacific Business Press Inc., 2000, ISBN: 978-81-7833-123-2), “Plastics and the Environment” (Anthony Andrady, ed., Wiley-Interscience, 2003, ISBN: 0-471-09520-6), “Plastic Materials and Processes: A Concise Encyclopedia” (Harper and Petrie, Wiley-Interscience, 2003, ISBN: 0-471-45603-9), and/or “Degradable Polymers, Recycling, and Plastics Waste Management (Albertsson and Huang, ed., 1995, ISBN: 0-8247-9668-3), for example (each of these references are herein incorporated by reference in their entireties).

In certain embodiments, it is contemplated that the heat-releasable material may be selected and/or configured to dissolve, melt, disintegrate, degrade, and/or evaporate upon artificial heating by appropriate selection of the heat-releasable material itself, and/or by appropriate structural design of the heat-releasable material. By way of example, the heat-releasable material itself may be selected based on having a chemical property of dissolving, melting, disintegrating, degrading, and/or evaporating under the artificial heating conditions; the structural design of the heat-releasable material may be such that the heat-releasable material has a sufficient thickness, shape, and/or surface area such that it will dissolve, melt, disintegrate, degrade, and/or evaporate upon artificial heating; or any combinations thereof. As described in detail in the Examples below, the temperature at which a given heat-releasable material structure becomes structurally unstable so as to result in removal or detachment may be affected by the thickness and/or surface area of structure, meaning that the temperature(s) at which the identification element will be removed or detached can be adjusted or tuned not only through selection of heat-releasable material, but also through selection of shape and/or thickness.

Indeed, experiments (see also the Examples section below) with various polymeric materials that were submerged in a range of water temperatures from 20-100° C. indicated that thinner film-type materials quickly dissolved in the elevated water temperatures, particularly those materials selected for dissolution in lower water temperatures. As the materials increased in thickness, longer exposures and/or higher temperatures were needed to achieve the same level of dissolution in the experiments performed.

In certain embodiments, the heat-releasable material may dissolve, melt, disintegrate, degrade, and/or evaporate upon artificial heating above a temperature of at least about 40° C., depending on the conditions of the particular application(s) of interest. In certain embodiments, the heat-releasable material may dissolve, melt, disintegrate, degrade, and/or evaporate upon artificial heating to at least a temperature selected from within a range of about 40° C. to about 90° C., such as a temperature selected from within a range of about 50° C. to about 80° C. As will be understood, the heat-releasable material may be selected or designed to dissolve, melt, disintegrate, degrade, and/or evaporate when subjected to the artificial heating of the particular application(s) of interest. By way of non-limiting example, scalding processes typically used in meat processing may involve temperatures of about 50° C. to about 80° C., and flame-based processes in meat processing may involve much hotter temperatures (albeit typically for a shorter period of time). In certain embodiments, the heat-releasable material may dissolve, melt, disintegrate, degrade, and/or evaporate upon artificial heating above a temperature of at least about 50° C. (such as about 60° C. to about 70° C., for example). In still another embodiment, the heat-releasable material may dissolve, melt, disintegrate, degrade, and/or evaporate upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, 80° C. or higher, 81° C. or higher, 82° C. or higher, 83° C. or higher, 84° C. or higher, 85° C. or higher, 86° C. or higher, 87° C. or higher, 88° C. or higher, 89° C. or higher, or 90° C. or higher, or more. As will be understood, in certain embodiments disintegration/degradation/evaporation of the heat-releasable material may include burning of the heat-releasable material.

In yet another embodiment, the heat-releasable material may completely dissolve, melt, disintegrate, degrade, and/or evaporate upon artificial heating for about 1 hour or less. In still another embodiment, the heat-releasable material may completely dissolve, melt, disintegrate, degrade, and/or evaporate upon artificial heating for 10 minutes, 9 minutes, 8 minutes, 7 minutes, 6 minutes, 5 minutes, 4 minutes, 3 minutes, 2 minutes, or less.

In yet another embodiment of any of the identification element or identification elements described herein, the heat-releasable material may comprise a solid polymer material or resin which dissolves or melts upon artificial heating by exposure to a heated liquid or gas. In still another embodiment, the heated liquid or gas may comprise heated water or steam. In yet another embodiment, the heat-releasable material may comprise a polyvinyl alcohol-based resin which is water insoluble at normal environmental temperatures, and which is water soluble upon heating above normal environmental temperatures. In still another embodiment, the polyvinyl alcohol-based resin may be water soluble upon artificial heating above a temperature of at least about 50° C. In another embodiment, the polyvinyl alcohol-based resin may be water soluble upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more. In yet another embodiment, the heat-releasable material may comprise a polyvinyl alcohol-based material which is substantially insoluble in water at temperatures up to at least about 40° C., and which becomes water soluble at a temperature no less than about 50° C. In another embodiment, the heat-releasable material may comprise a Hydropol™ polymer, for example. In certain embodiments, the heat-releasable material may be or comprise Hydropol™ 30124, 30163, 30164, or 33104, or a similar such resin or polymer, or a functional equivalent or derivative thereof.

In certain embodiments, such as certain embodiments where the identification element is to be used for tracking and/or identification or a livestock animal intended for meat production or in another food-related application, it is contemplated that the heat-releasable material may be selected such that the heat-releasable material (or the dissolved, melted, disintegrated, degraded, and/or evaporated form thereof resulting from artificial heating) is non-toxic and generally food-safe, to further reduce risk in applications or conditions for which there may be concern of the heat-releasable material unintentionally becoming incorporated into the food product.

In still another embodiment of any of the identification element or identification elements described herein, it is contemplated that the unique identifier element may be fabricated of a material that dissolves, melts, disintegrates, degrades, and/or evaporates upon artificial heating.

For example, the unique identifier element may be manufactured from a heat-releasable material, or the unique identifier may be integrated with (such as by stamping, printing, inking, or otherwise marking on, for example) heat-releasable material of the attachment fitting. Such configurations may simplify disposal of the unique identifier element, for example. Alternatively, in certain embodiments, the unique identifier element may be selected and/or configured to be resistant to artificial heating such that the unique identifier element may be recoverable following removal or detachment of the identification element from the livestock animal (or the subject or article of interest), which may allow for reuse thereof. Such configurations may be desirable where expensive and/or sophisticated unique identifiers are used (such as Bluetooth and/or RFID tags, or GPS enabled tags), for example.

In certain embodiments, the identification elements as described herein may be marked with ink or impregnated with materials or devices useful for the unique identification of an individual (e.g. may be serialized) as the unique identifier element. In certain embodiments, the unique identifier element may comprise a simple alpha numeric text printed on or within the identification element, an embedded electronic chip with serialized information, a crystalline material or other such material or structure giving off or providing a uniquely identifiable light signature, or an ink/substance with unique detectable properties (such as a nano-particle infused ink(s) or compound(s), in particular those that are non-toxic, approved for use in food, or edible). Such inks or compounds may dissolve or disperse along with the identification element, or remain intact, but fall away, or separate from the rest of the identification element (for example, by being washed away in water/dissolving liquid, or combustible in a heat source/flame, during artificial heating, for example). In certain embodiments, the unique identifier element may have similar physical characteristics to the rest of the identification element material, in that the unique identifier element may be configured to disperse or dissolve in the heated water or during the artificial heating, but would allow for unique serialization of the identification element while in use prior to artificial heating.

In further embodiments, it is envisioned that unique identifier elements may alternatively or additionally be applied directly onto the animal and/or under the skin of the animal, using a food-safe, dissolving or dissipating ink, crystalline structure or ‘tattoo’ type marking. Direct application of unique identifier elements onto the animal in this manner enables the use of unique identifying methodologies for complete traceability right on the animal.

In another embodiment, there is provided herein a method for identifying and/or tracking a livestock animal, said method comprising:
securing any of the identification element or identification elements as described herein to the livestock animal;
using the identification element to uniquely identify and/or track the livestock animal over a period of time; and
removing or detaching the identification element from the livestock animal prior to or during production of meat from the animal.

In still another embodiment of the above method, the step of removing or detaching may comprise exposing the identification element to artificial heating as described in detail herein. In yet another embodiment, the step of removing or detaching may comprise a scalding or flame-based hair removal stage of a meat production process.

In yet another embodiment, the step of using the identification element to unique identify and/or track the livestock animal may comprise detecting or reading the unique identifier element of the identification element visually, by an electronic scanning means, or by another detection technology suitable for the type of unique identifier element being employed (e.g. detection by visual analysis, barcode scanning, radio frequency detection, nano-particle ‘signature’ detection, or another other such detection approach suitable for the type of unique identification element being used).

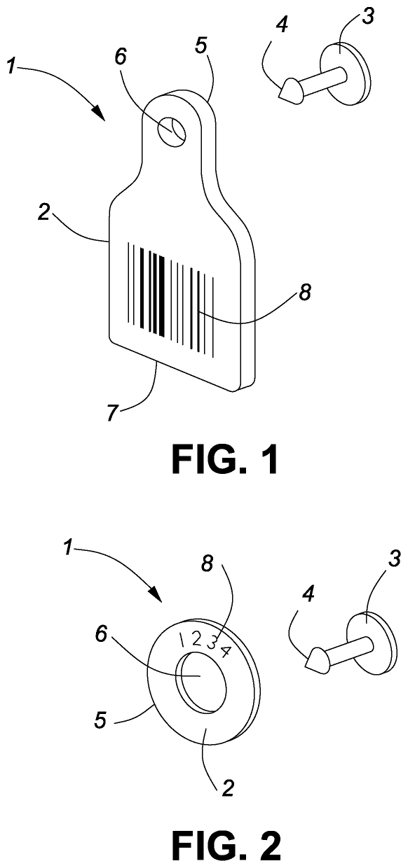

FIGS. 1-4, 7A, 7B and 8-11 depict preferred embodiments of identification elements as described herein. FIG. 1 shows an example of an ear tag-type identification element for identification and/or tracking of livestock. The identification element (1) comprises an attachment fitting (2) for securing the identification element to a livestock animal. The attachment fitting (2) includes both a male portion (3) with a widened end (4), and a co-operating female receiving portion (5) which receives the male portion therein. The male portion (3) extends through an ear piercing of the livestock animal, and is received through an aperture (6) of the female receiving portion and held therein by the widened end (4). The attachment fitting (2) further includes a body (7) extending from the female receiving portion. A unique identifier element (8), in the form of a barcode, is imprinted in ink on the body (7) of the attachment fitting. In the depicted example, a second unique identifier element is provided, in the form of an RFID tag, which is embedded within the body (7) of the attachment fitting (2). In the depicted example, the entire attachment fitting (2) is formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal. An alternative embodiment is also contemplated, in which only the widened end (4) of the male portion (3) of the attachment fitting (2) is formed of the heat-releasable material, such that upon artificial heating the widened end (4) dissolves, melts, disintegrates, degrades, and/or evaporates, freeing the male portion (3) from the female receiving portion (5), resulting in detachment of the identification element from the livestock animal, and allowing for recovery of the female receiving portion (5) and the RFID tag therein, allowing for reuse.

FIG. 2 shows another example of an ear tag-type identification element for identification and/or tracking of livestock. The identification element (1) comprises an attachment fitting (2) for securing the identification element to a livestock animal. The attachment fitting (2) includes both a male portion (3) with a widened end (4), and a co-operating female receiving portion (5) which receives the male portion therein. The male portion (3) extends through an ear piercing of the livestock animal, and is received through an aperture (6) of the female receiving portion and held therein by the widened end (4). A unique identifier element (8), in the form of an alphanumeric number, is stamped into the outer circumference of the female receiving portion (5) of the attachment fitting. In the depicted example, the entire attachment fitting (2) is formed of a heat-releasable material which is solid at normal environmental temperatures, and which dissolves, melts, disintegrates, degrades, and/or evaporates upon artificial heating above normal environmental temperatures, such that artificial heating results in removal of the identification element from the livestock animal.

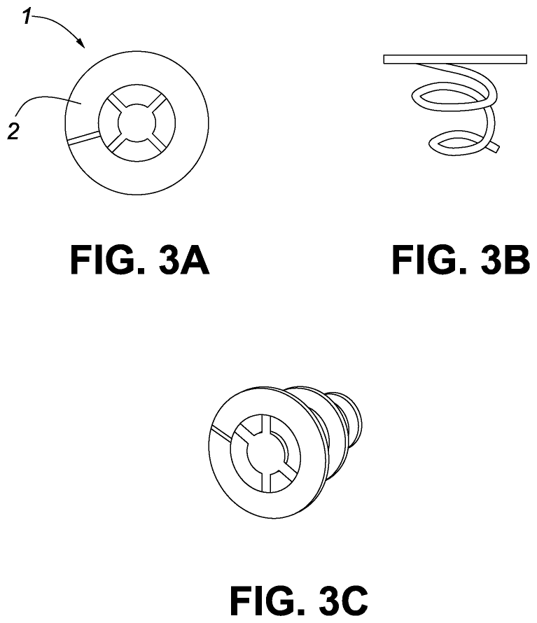

FIG. 3A shows an example of a tail tag-type identification element for identification and/or tracking of livestock. The identification element (1) comprises an attachment fitting (2) for securing the identification element to a livestock animal. The attachment fitting (2) comprises a single-piece conical spring-type structure (as further depicted in FIGS. 3B (side view) and 3C (isometric view)), designed to elongate radially as the animal grows. A unique identifier element, in the form of a barcode sticker (not shown), is glued to a portion of the attachment fitting (2). In the depicted example, the entire attachment fitting (2) is formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal. The sticker-type unique identifier element may be destroyed or degraded by the artificial heating, or may be collected and disposed of following removal.

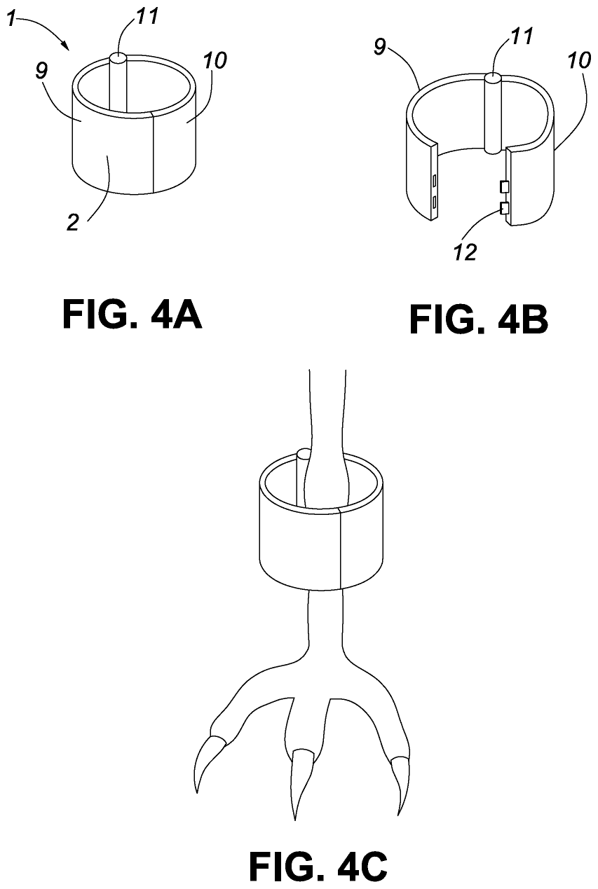

FIGS. 4A and 4B show an example of a leg bracelet-type identification element for identification and/or tracking of livestock, the leg tag-type identification element being in the form of a hinged snap-lock type ankle bracelet. The identification element (1) comprises an attachment fitting (2) for securing the identification element to a leg of the livestock animal. The attachment fitting (2) includes two rounded sections (9) and (10) operable about a hinge (11) to allow opening and closing around the leg of the animal. Once installed on the animal, the bracelet is held closed by a snap-lock closing mechanism (12) (or another such latch mechanism) of the attachment fitting (2). A unique identifier element (not visible), in the form of an RFID tag and GPS unit, is installed (by fastening) to an exterior surface of rounded section (10) of the attachment fitting. In the depicted example, a portion of the snap-lock closing mechanism (12) of the attachment fitting (2) is formed of a heat-releasable material which is solid at normal environmental temperatures, and which dissolves, melts, disintegrates, degrades, and/or evaporates upon artificial heating above normal environmental temperatures, such that artificial heating results in opening of the hinged rounded sections leading to detachment of the identification element from the livestock animal, and allowing for recovery of the bracelet and the RFID tag and the GPS unit, allowing for reuse. FIG. 4C shows the leg bracelet-type identification element installed on the leg of a poultry animal.

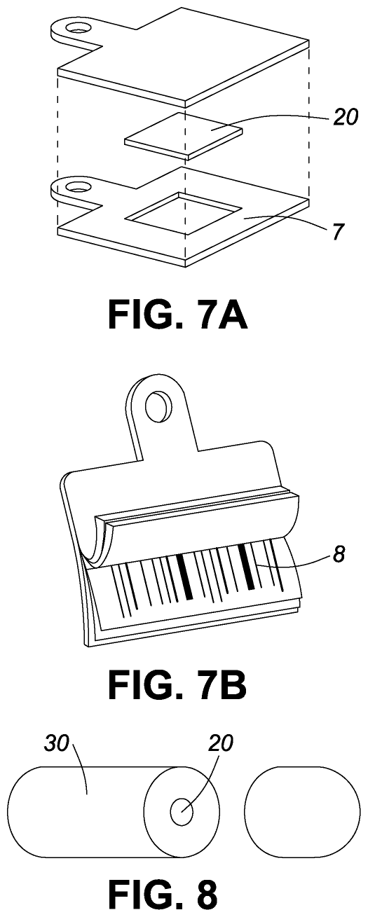

FIG. 7A shows an exploded view of an example of the ear tag-type identification element illustrated in FIG. 1. As illustrated, the second unique identifier element is provided in the form of an RFID tag or chip (20), embedded within the body (7) of an injection moulded attachment fitting. In FIG. 7B, the unique identifier element (8), in the form of a barcode (or alternatively in the form of a QR code), is imprinted within polymer layers forming the body (7).

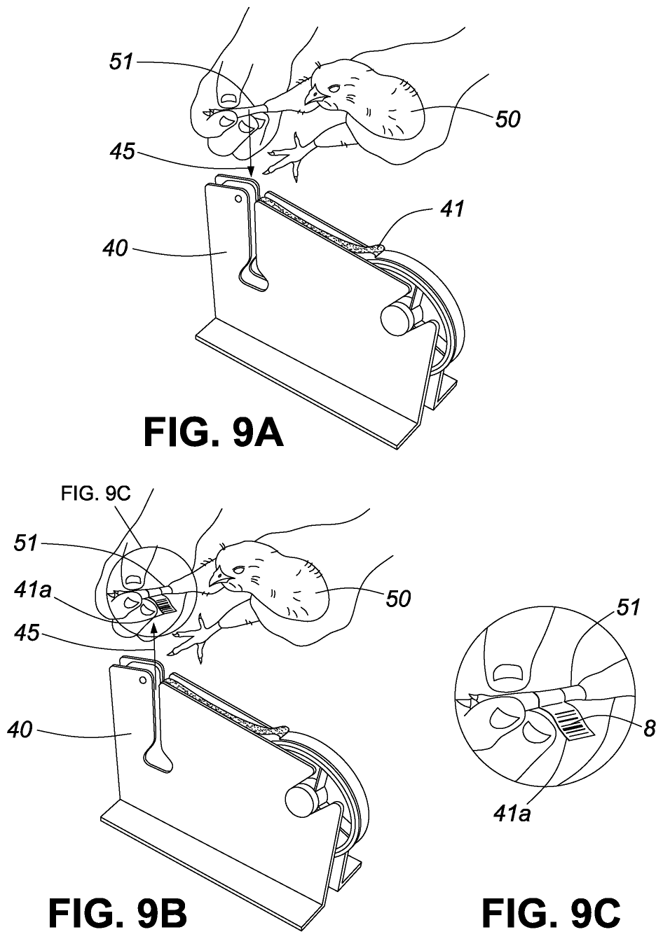

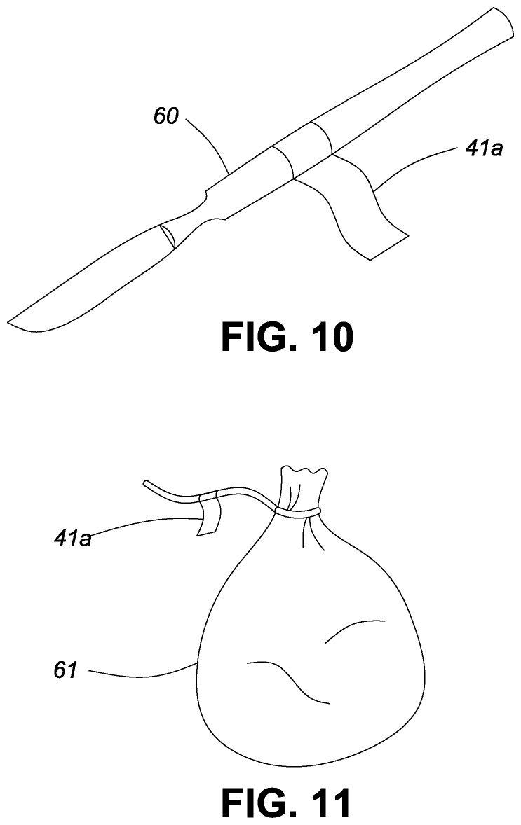

FIG. 9 illustrates a further possible embodiment of an identification element in which a tape or label-type identification element is applied for identification and/or tracking of livestock. In the illustrated example, a tape/label dispenser (40) or similar applicator is used to apply a label (41a) from a tape roll (41) to an extremity of an animal. FIG. 9A shows the user applying the label (41a) to the leg (51) of a chick (50) by passing the chick's leg (51) downward through the opening (45) of the tape/label dispenser (40), such that the chick's leg (51) passes over adhesive tape fed from a roll (41), and through the mechanism of the tape/label dispenser (40) where the tape is applied and secured together by the tape adhesive, and then cut to a predetermined length. As shown in FIG. 9B, the chick's leg (51) is then moved back upward again through the opening (45) of the tape/label dispenser (40), with the label (41a) affixed. FIG. 9C shows a magnified view of the chick's leg (51) with the label (41a) affixed, and a unique identifier element (8), in the form of a barcode (or alternatively in the form of a QR code), imprinted thereon. FIG. 10 illustrates a further example of the tape or label style identification element shown in FIG. 9, applied to a surgical tool or knife (60) marked for disinfecting after medical use, using the tape/label dispenser (40) to apply label (41a). FIG. 11 illustrates yet another example of the tape or label style identification element shown in FIG. 9, applied in this case to a drawstring of a bag of laundry (61) marked for cleaning and/or pickup, using the tape/label dispenser (40) to apply label (41a). In each of these examples a unique identifier element, e.g. in the form of a barcode or QR code, is imprinted in ink on the label (41a). In these examples the label (41a) and/or the tape adhesive thereof is formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal (50), surgical tool (60), or laundry bag (61). In the case of objects marked for cleaning and/or disinfection such as surgical tool (60) or laundry bag (61), it is envisioned that the items may be identified or otherwise considered “clean” or “disinfected” once the identification element, e.g. label (41a), dissolves, melts, disintegrates, degrades, and/or evaporates upon artificial heating during a cleaning or disinfecting process.

In yet another embodiment, there is provided herein an identification element comprising:
an attachment fitting for securing the identification element to a subject or article of interest; and
a unique identifier element affixed to, integrated with, or embedded in the attachment fitting;
at least a portion of the attachment fitting being formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the subject or article of interest.

In another embodiment of the above identification element, the heat-releasable material may dissolve, melt, disintegrate, degrade, and/or evaporate upon artificial heating above a temperature as already described in detail hereinabove. In certain embodiments of the above identification element, the heat-releasable material may dissolve, melt, disintegrate, degrade, and/or evaporate upon artificial heating above a temperature of at least about 50° C. In still another embodiment, the heat-releasable material may dissolve, melt, disintegrate, degrade, and/or evaporate upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more. In yet another embodiment, the heat-releasable material may completely dissolve, melt, disintegrate, degrade, and/or evaporate upon artificial heating for about 1 hour or less. In still another embodiment, the heat-releasable material may completely dissolve, melt, disintegrate, degrade, and/or evaporate upon artificial heating for 10 minutes, 9 minutes, 8 minutes, 7 minutes, 6 minutes, 5 minutes, 4 minutes, 3 minutes, 2 minutes, or less.

In yet another embodiment, the heat-releasable material, polymer material, or resin may comprise one or more of a polyvinyl alcohol (such as a polyvinyl alcohol based resin or polymer); an alkali-soluble resin; cellulose; a cellulose chemical derivative; a hydrophilic polymer; carboxymethyl cellulose; hydroxyethyl cellulose; Polyox; alginate; polyacrylamide; poly(acrylic acid); poly(methacrylic acid); polyethylene oxide; a starch; or a gelatin; or any combinations thereof wherein the heat-releasable material is configured and/or designed such that the heat releasable material is solid at normal environmental temperatures, and which dissolves, melts, disintegrates, degrades, and/or evaporates upon artificial heating above normal environmental temperatures, such that artificial heating results in removal or detachment of the identification element from the subject or article of interest. As will be understood, the heat-releasable material may be tailored or selected to suit the particular application(s) of interest and conditions thereof.

In certain embodiments, the heat-releasable material may comprise a polymer material or resin. In yet another embodiment, the polymer material or resin may comprise a polyvinyl alcohol-based resin. In another embodiment, the heat-releasable material may comprise a solid polymer material or resin which dissolves or melts upon artificial heating by exposure to a heated liquid or gas. In still another embodiment, the heated liquid or gas may comprise heated water or steam. In yet another embodiment, the heat-releasable material may comprise a polyvinyl alcohol-based resin which is water insoluble at normal environmental temperatures, and which is water soluble upon heating above normal environmental temperatures. In another embodiment, the polyvinyl alcohol-based resin may be water soluble upon artificial heating above a temperature of at least about 50° C. In still another embodiment, the polyvinyl alcohol-based resin may be water soluble upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more. In yet another embodiment, the heat-releasable material may comprise a polyvinyl alcohol-based material which is substantially insoluble in water at temperatures up to at least about 40° C., and which becomes water soluble at a temperature no less than about 50° C. In another embodiment, the heat-releasable material may comprise a Hydropol™ polymer. In still another embodiment, the heat-releasable material may comprise Hydropol™ 30124, 30163, 30164, or 33104.

In another embodiment, the identification element may be in the form of a tag, band, bracelet, collar, spring, or clip. In another embodiment, the attachment fitting may comprise a rivet, snap, hook, tie, loop, strap, hinge, clip, pin, spring, latch, or other friction fit or fastening mechanism for securing the identification element to the subject or article of interest, wherein heating the heat-releasable material disengages or destroys the fastening mechanism, thereby removing or detaching the identification element from the subject or article of interest. In yet another embodiment, all or substantially all of the attachment fitting may be formed of the heat-releasable material.

In another embodiment, the unique identifier element may comprise a label, barcode, RFID identifier, or any combination thereof. In another embodiment, the unique identifier element may comprise a label and/or barcode providing identifying detail(s) for the subject or article of interest that is/are readable visually, electronically, or both.

In still another embodiment, the unique identifier element may be fabricated of a material that dissolves, melts, disintegrates, degrades, and/or evaporates upon artificial heating; or the unique identifier element may be resistant to artificial heating and may be recoverable following removal or detachment of the identification element from the subject or article of interest.

In another embodiment, there is provided herein a use of the identification element for identifying and/or tracking a subject or article of interest. In another embodiment, there is provided herein a method for identifying and/or tracking a subject or article of interest, said method comprising:
securing any of the identification element or identification elements as described herein to the subject or article of interest;
using the identification element to uniquely identify and/or track the subject or article of interest over a period of time; and
removing or detaching the identification element from the subject or article of interest by artificially heating the identification element.

In another embodiment, the step of removing or detaching the identification element may comprise exposing the identification element to hot water or steam.

In another embodiment, there is provided herein a method for identifying and/or tracking a subject or article of interest, said method comprising:
securing an identification element to the subject or article of interest, the identification element comprising an attachment fitting for securing the identification element to the subject or article of interest, and a unique identifier element affixed to, integrated with, or embedded in the attachment fitting, wherein at least a portion of the attachment fitting is formed of a heat-releasable material which is solid at normal environmental temperatures, and which dissolves, melts, disintegrates, degrades, and/or evaporates upon artificial heating above normal environmental temperatures;
using the identification element to uniquely identify and/or track the subject or article of interest over a period of time; and
removing or detaching the identification element from the subject or article of interest by artificially heating the identification element such that the artificial heating results in removal or detachment of the identification element from the subject or article of interest.

In certain non-limiting examples and embodiments of identification element or identification elements as described herein, the heat-releasable material and/or the artificial heating conditions may be selected such that at least some of the heat-releasable material melts, evaporates, or both, upon artificial heating, wherein the melting and/or evaporation may involve change of state (for example, changing from a solid to a liquid or gas of at least some of the heat-releasable material). In certain non-limiting examples and embodiments of identification element or identification elements as described herein, the heat-releasable material and/or the artificial heating conditions may be selected such that at least some of the heat-releasable material melts upon artificial heating, wherein the melting of the heat-releasable material may involve softening of at least some of the heat-releasable material (i.e. becoming less structurally stable and/or weakened). In certain non-limiting examples and embodiments of identification element or identification elements as described herein, the heat-releasable material and/or the artificial heating conditions may be selected such that at least some of the heat-releasable material disintegrates, degrades, and/or evaporates, wherein disintegration, degradation, and/or evaporation may optionally involve burning or combustion of at least some of the heat-releasable material. In certain non-limiting examples and embodiments of identification element or identification elements as described herein, the heat-releasable material and/or the artificial heating conditions may be selected such that at least some of the heat-releasable material dissolves, melts, disintegrates, degrades, and/or evaporates upon artificial heating, wherein dissolution, melting, disintegration, degradation, and/or evaporation of the heat-releasable material may optionally include a change in size of at least some of the heat-releasable material, for example shrinkage of the heat-releasable material, upon artificial heating.

In another embodiment, there is provided herein an implantable identification element for livestock or another subject or article of interest, comprising:
a housing; and
a unique identifier element affixed or joined to, integrated with, housed within, or embedded in the housing;
at least a portion of the housing being formed of a heat-releasable material which is solid at normal environmental temperatures, and which dissolves, melts, disintegrates, degrades, and/or evaporates upon artificial heating above normal environmental temperatures, such that artificial heating results in removal of the identification element from the livestock animal/subject/article of interest, destruction of the identification element, or both.

As will be understood, although identification elements have primarily been described herein as being configured to be secured to an exterior of a livestock animal/subject/article of interest (as in the case of ear tags and bracelets, for example), identification elements as described herein may also be adapted to be implantable or embeddable in the livestock animal or other subject or article of interest. Where implantation or embedding of the identification element is desired, the attachment fitting may in certain embodiments be modified to a housing, typically an outer housing or protective shell, and the unique identifier element may be affixed or joined to, integrated with, housed within, or embedded in the housing. At least a portion of the housing may be formed of the heat-releasable material which is solid at normal environmental temperatures, and which dissolves, melts, disintegrates, degrades, and/or evaporates upon artificial heating above normal environmental temperatures, such that artificial heating results in removal of the identification element from the livestock animal/subject/article of interest, destruction of the identification element, or both.

FIG. 8 shows a cutaway view of one possible example of an implantable or embeddable identification element. In the non-limiting embodiment illustrated, the identification element (30) comprises a body (30) formed of a heat activated dissolvable implant material. Embedded within the body (30) is a unique identifier element, in the form of an RFID tag or chip (20).

In certain embodiments, the implantable identification element may be for implantation/insertion under the skin of the animal or subject, or may otherwise be implanted, embedded, or introduced into the body of the animal or subject, and may be used for identification and/or tracking through the life of the animal, or a particular time period thereof, for example.

In certain embodiments, the implantable identification element, or at least the housing and heat-releasable material thereof, may be designed or selected to dissolve, melt, disintegrate, degrade, and/or evaporate under artificial heating, such that artificial heating results in removal/detachment/separation of the identification element from the livestock animal/subject/article of interest, destruction/break down of the identification element, or both.

In embodiments such as those involving meat production, the implantable identification element may be configured such that artificial heating either results in detachment/separation of the implanted identification element from the livestock animal carcass, or results in thorough break-down of the implanted identification element, such that the implanted identification element is eliminated and does not present foreign material risks. In certain embodiments, the implantable identification element may be designed/configured to be food safe, and the artificial heating may cause thorough breakdown of the implanted identification element (both the housing and the unique identifier element) such that any remaining residue may be acceptable (depending on the concentrations post-washing—all safety considerations should be carefully verified for each particular application).

In certain embodiments of implantable identification elements as described herein, the unique identifier element may be selected to provide wireless identification (such as by RFID, transponder, Bluetooth, or another such detectable signal, for example) that can be detected for identification/tracking purposes without requiring direct physical access to the implanted/embedded identification element. Such wireless identification may be desirable for tracking/identification of certain subjects or articles of interest. Where a livestock animal intended for meat production is to be identified and/or tracked, and the unique identifier element comprises a wireless component (or other component) that is resistant to degradation, the implantable identification element may be implanted at a region of the animal that is not used for food production so as to avoid risk of food contamination; or the implantable identification element may be configured and implanted such that dissolution, melting, disintegration, degradation, and/or evaporation of the heat-releasable material of the housing upon artificial heating results in the implanted identification element becoming separated or ejected from the livestock animal (for example, the implanted identification element may decrease in size upon artificial heating, allowing the implanted identification element to exit or be ejected from an opening of the livestock animal).

In certain embodiments, the entire implantable identification element (both the housing and the unique identifier element) may be designed and configured such that it dissolves, melts, disintegrates, degrades, and/or evaporates upon the artificial heating so as to be sufficiently eliminated to not present foreign material risks. In certain embodiments, the implantable identification element may be designed/configured to be food safe, and the artificial heating may cause thorough breakdown of the implanted identification element (both the housing and the unique identifier element) such that any remaining residue may be acceptable (depending on the concentrations post-washing—all safety considerations should be carefully verified for each particular application). By way of example, in certain embodiments the implantable identification element may comprise a housing formed entirely of a food-safe heat-releasable material that dissolves under the artificial heating, and the unique identifier element may comprise a barcode and/or identification number printed (in food-safe ink) on a surface of the housing, and the implantable identification element may be for implantation at a shallow depth below the skin of the livestock animal such that it remains visible and readable through the skin of the animal. The artificial heating may cause thorough breakdown of the housing and breakdown or dispersion of the food-safe ink, such that any remaining residue may be acceptable (note that all safety considerations should be carefully verified for each particular application).

By way of another example, in certain embodiments the implantable identification element may comprise a housing formed entirely of a food-safe heat-releasable material that dissolves under the artificial heating, and the unique identifier element may comprise a barcode and/or identification number printed (in food-safe ink) on a surface of a cellulose or dissolvable food-safe paper, wherein the housing is provided in the form of a film coating the unique identifier element (i.e. coating the cellulose or dissolvable food-safe paper), and the implantable identification element may be for implantation at a shallow depth below the skin of the livestock animal such that it remains visible and readable through the skin of the animal. The artificial heating may cause thorough breakdown of the housing (i.e. the film) leading to dissolution of the unprotected dissolvable food-safe paper, such that any remaining residue may be acceptable (note that all safety considerations should be carefully verified for each particular application).

In certain embodiments of any of the identification element or identification elements as described herein, at least a portion of the attachment fitting/housing of the identification element may be formed of a heat-releasable material as described herein and may be configured in the form of a film-type outer coating(s) or layer(s), an outer sleeve or casing, or another outer coating, film, casing, or enclosure-type protective barrier(s) or layer(s), coating or otherwise encompassing or enveloping at least part of the unique identifier element of the identification element so as to provide protection and longevity of the unique identifier element while the heat-releasable material remains intact. In certain embodiments, upon artificial heating the unique identifier element may become exposed, and may lead to degradation of the unique identifier element, or detachment or removal from the livestock animal or subject or article of interest. By way of example, in certain embodiments at least a portion of the attachment fitting/housing may be formed of the heat-releasable material, and may be configured in the form of one or more outer coatings or barriers applied to the exterior of the unique identifier element, wherein the one or more outer coatings or barriers may optionally be applied by way of painting or spraying onto the exterior of the unique identifier element, by way of submerging or dipping the unique identifier element into a liquid comprising the heat-releasable material followed by drying or curing to form outer coating(s) or barrier(s), or any other suitable technique for applying the outer coating(s) or barrier(s) to the exterior of the unique identifier element. In certain embodiments, the outer coating or barrier may be applied as one layer, or may be applied as two or more layers which may be the same or different from one another.

In certain embodiments, the unique identifier element may comprise a paper or similar type of material, such that the identification element may comprise a film-coated paper, for example, which may provide a combination of strong/resistant/protective outer shell/coating able to withstand the normal elements and conditions of the farm/production environment, and that may dissolve, melt, disintegrate, degrade, and/or evaporate away upon exposure to artificial heating (for example by heating with flame or submersion in heated water, or both), allowing for the underlying unique identifier element (e.g. the paper or similar type of material) to dissolve or disintegrate, degrade, and/or evaporate (for example, the unique identifier element may combust) more rapidly (for example, the unique identifier element may combust during a singing process as described hereinabove, or may rapidly dissolve in hot water upon deterioration of the outer film coating). In certain embodiments, the unique identifier element may comprise one or more cellulose and/or starch-based components (e.g. paper or similar material), and may dissolve or disintegrate, degrade, and/or evaporate (for example, combust) upon artificial heating, leading to breakdown and/or removal and/or detachment from the livestock animal or subject or article of interest, similarly to the heat-releasable material of the attachment fitting/housing of the identification element.

In still another embodiment, there is provided herein an identification element for a livestock animal or other subject or article of interest, the identification element comprising:
a unique identifier element; and
an outer protective barrier encompassing at least a portion of the unique identifier element, the outer protective barrier comprising at least one of: a film-type outer coating or layer; an outer sleeve or casing; or another outer coating, film, casing, or enclosure;
at least a portion of the outer protective barrier being heat-releasable, such that the outer protective barrier remains intact and provides protection of the unique identifier element under normal environmental temperatures, and releases or exposes the unique identifier element when subjected to artificial heating.

In yet another embodiment of the above identification element, at least a portion of the outer protective barrier may comprise or may be formed of a heat-releasable material which is solid at normal environmental temperatures, and which dissolves, melts, disintegrates, degrades, and/or evaporates upon artificial heating above normal environmental temperatures.

In still another embodiment of the above identification element or identification elements, the unique identifier element may be formed of paper or other such material, such as a cellulose and/or starch-containing material.

In yet another embodiment, there is provided herein an identification element for livestock or another subject or article of interest, comprising:
an attachment fitting for securing the identification element to a livestock animal or other subject or article of interest; and
a unique identifier element affixed to, integrated with, or embedded in the attachment fitting;
wherein the attachment fitting remains secured to the livestock animal or other subject or article of interest under normal environmental temperatures, and wherein the attachment fitting is heat-releasable such that artificial heating above normal environmental temperatures results in removal or detachment of the identification element from the livestock animal or other subject or article of interest.

As will be understood, a variety of different attachment fittings are contemplated herein, and may comprise any suitable attachment fitting that is heat-releasable such that artificial heating above normal environmental temperatures results in removal or detachment of the identification element from the livestock animal. By way of example, heat-releasable attachment fittings may comprise attachment fittings designed or configured to release or fail upon exposure to the artificial heating. A variety of different heat-releasable attachment fittings are contemplated. By way of non-limiting example, suitable attachment fittings may include those employing one or more heat-releasable materials to provide heat releasability upon exposure to the artificial heating (for example, through failure of one or more attachment fitting components formed of the heat-releasable material), many examples of which are described in detail herein.

### EXAMPLE 1— Testing of Heat-Releasable Materials Under Artificial Heating Conditions

This example sets out the results of testing performed on various heat-releasable materials exposed to artificial heating conditions. In this example, a variety of polyvinyl alcohol (PVOH) resins were subjected to artificial heating conditions in the form of submersion in hot water, and their dissolution rates and characteristics were determined. In addition to testing different resins, these tests also studied different thicknesses, shapes, and surface areas of the heat-releasable materials to determine how these structural factors affect dissolution under artificial heating conditions.

Materials remaining substantially structurally intact under normal temperatures and environmental conditions (which may include normal indoor and outdoor temperatures, rain and sunshine, moisture and humidity, abrasion, and/or exposure to acidic or alkaline conditions), while becoming structurally unstable under artificial heating, may provide particularly desirable heat-releasable materials. Several polyvinyl alcohol-based materials are tested in this example to determine their response to artificial heating by submersion in hot water of varying temperature.

Materials and Methods:

The material characteristic of having the ability to break down (e.g. to become structurally unstable by dissolution and/or melting) upon the application of artificial heating conditions mimicking traditional hair removal meat processing conditions (e.g. scalding submersion, steam and/or flame) was evaluated. Initial testing was designed to simulate submersion scalding conditions at elevated temperatures for a pre-set period of time.

A standard heating element was used as the source of heat for a container of water. The water temperatures were adjusted with the application of heat energy through a range of room temperature (20° C.) to boiling (100° C.). The materials tested included four different types of Hydropol™ polymers (material numbers: 30124, 30163, 30164, and 33104) commercially available from Aquapak Polymers, in pellet and sheet forms. The pellets are approximately 1-2 mm in diameter, and the sheets were 25, 35 and 80 microns thick.

The temperatures were adjusted throughout the experiment and various observations were made at key temperatures (20° C., 40° C., 60° C., 80° C. and 100° C.). The temperatures of 20° C. and 40° C. were considered important in that it was desirable for the material to avoid breakdown below 40° C., as those conditions might exist in certain livestock production environments (depending on the animal and climate), including higher humidity levels, which would be exaggerated during the submersion trials. The temperatures of 50-80° C. simulate the conditions that often exist in the submersion scalding process at typical livestock processing facilities. The process is designed for loosening hair in the follicle; however, as described in detail herein may also provide an opportunity to remove the identification elements as described herein without needing human invention and without causing damage to the carcass/food. The temperature range of 80-100° C. was also evaluated in order to understand the material's reaction at elevated temperatures; although these might be less common in the processing environment with current traditional processing, it is contemplated that processors may in some implementations modify processing to add equipment that can run higher temperatures, in order to remove identification elements without additional human labour or risk to the meat product.

Results:

In initial studies, the materials were tested at a variety of temperatures in pellet and sheet/film form to observe their response to elevated temperatures. The films were cut into 2″×2″ squares and were observed to be more reactive to the elevated temperatures than the same materials in pellet form. In general, the films all dissolved between 50° C.-80° C., and appeared to remain substantially intact at temperatures below 50° C. in the conditions tested.

The pellets were observed to become soft at elevated temperatures, but took longer to break down. With 2 of the material formulations (30163 and 30164), the pellets did not dissolve completely, even at temperatures above 80° C. 30124 and 33104 were observed to break down more rapidly than 30163 and 30164, indicating that formulations may be adjusted or tailored for breakdown at particular temperatures or temperature ranges as desired and/or according to the particular application(s) of interest.

Materials intended to breakdown at lower temperatures (50° C.) were observed to be more reactive than those formulated for higher temperatures (80° C.), and were quicker to dissolve in both film and pellet form. Material 33104 was observed to have the best dissolution properties with both the pellets and films dissolving within 5 minutes at 50° C.

Results from this initial testing indicated that the reduced surface area of the pellet, as compared to the film squares, along with the increased thickness of the pellet, required additional time and temperature to dissolve.

### DISCUSSION

In these initial studies, there was a significant difference in the dissolution times for the various materials, suggesting that formulations and systems may be fine tuned to provide complete dissolution within a typical 5 minutes of submersion scalding process often used at traditional processing facilities, while still remaining structurally stable at temperatures around 40° C. and cooler which may be experienced from time-to-time in the farming environment, including elevated humidity levels.

Given the typical finite amount of time in scalding submersion or exposure to steam/flame for hair removal at traditional processing facilities, it is determined that thickness, density, and/or surface area parameters may be adjusted as desired to provide suitable characteristics for the particular application. It is also contemplated that a hollow element or thinner film-like structure may be used where faster or more thorough break down (e.g. dissolution and/or melting) is desired during standard submersion processing/scalding conditions. A more solid construct is more likely to withstand production (barn, etc. . . . ) conditions better, and so for particular rigorous conditions where extra resilience is desired a thicker or more robust design may be used, although this may take longer to break down under artificial heating (unless higher temperature is used). It is contemplated that density to surface area ratio may be adjusted accordingly to suit the particular application and conditions thereof. It is contemplated that layers of film-like material may provide for additional wear resistance, while still allowing for dissolution within a 4-6 minute window common at the processing facility during hair removal. In other embodiments, it is contemplated that the flame singer hair removal approach might be utilized as a second step, which may breakdown a different, more combustible material, such as paper, that the film layers may be protecting until after submersion scalding is complete. In examples using a flame singer hair removal approach, experienced temperatures may be higher, allowing for rapid break down even for thicker and/or more dense materials that may provide for more robust or resilient designs for life on the farm. Configurations, and treatment conditions, may be selected to suit the particular application, as desired.

### EXAMPLE 2— Additional Testing of Heat-Releasable Materials Under Artificial Heating Conditions

This example sets out the results of additional testing performed on various heat-releasable materials exposed to artificial heating conditions. In this example, a variety of polyvinyl alcohol (PVOH) resins were subjected to artificial heating conditions in the form of submersion in hot water, and their dissolution rates and characteristics were determined. In addition to testing different resins, these tests also studied different thicknesses, shapes, and surface areas of the heat-releasable materials to determine how these structural factors affect dissolution under artificial heating conditions.

The materials and methods used in these studies were very similar to those described in Example 1 above, with some exceptions. Specifically, the testing in this Example focussed mainly on film materials to further investigate the dissolution properties at the various temperatures (due to their quicker reactions). The materials used were Hydropol™ polymers 30164, 30163, 30124 and 33104 commercially available from Aquapak Polymers. The dissolution percentage was based on the surface area of the samples that had dissolved (50% and 95%) at a point in time during the submersion in heated water. A stop watch timer was used to measure the time that it took for the samples to reach 50% and 95% dissolved.

Results and Discussion:

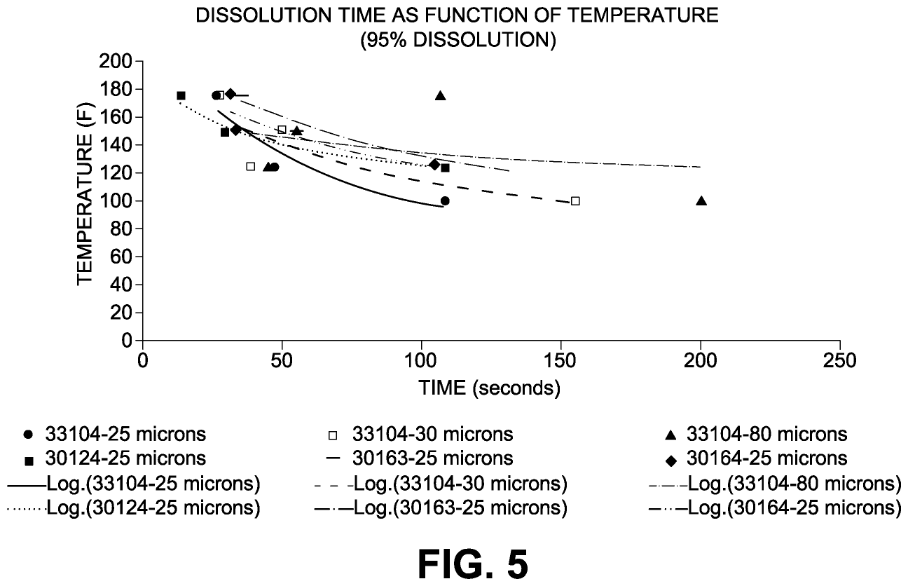

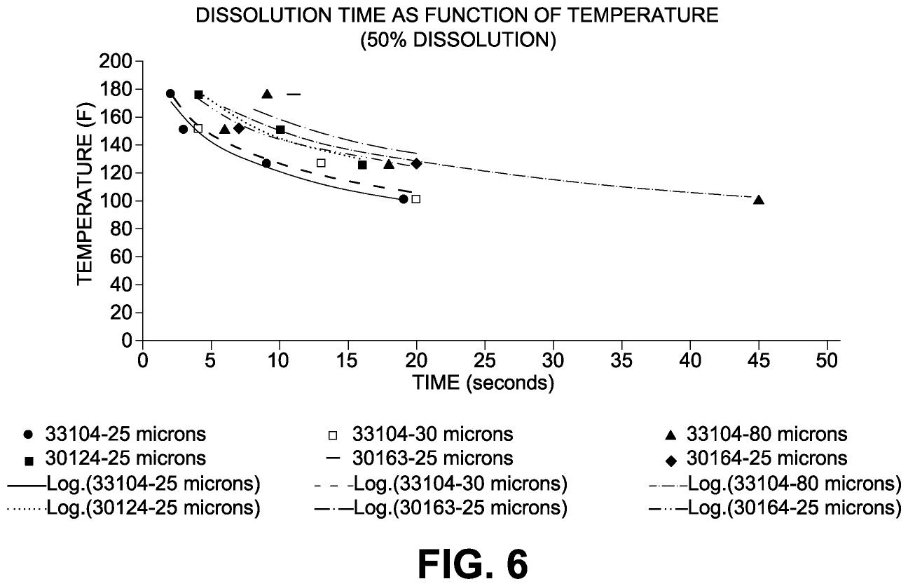

In this example, experiments were run on various materials in an effort to understand their properties within key process conditions identified to cause dissolution or breakdown. Results are provided in Table 1 below, and in FIGS. 5 and 6.

These experiments were run with test samples of 1″×2″ pieces of polymers of various thickness, and with pellets. The materials were placed in water at various temperatures as shown, and the dissolution rates/times were recorded (see Table 1 and FIGS. 5 and 6).

TABLE 1
Materials and Conditions used in testing,
as well as measured dissolution times.

| | | | Time to 50% | Time to 95% |
|---|---|---|---|---|
| | Thickness | Temperature | dissolution | dissolution |
| Material | (microns) | (Fahrenheit) | (seconds) | (seconds) |
| 33104 | 25 | 100 | 19 | 108 |
| 33104 | 25 | 125 | 9 | 47 |
| 33104 | 25 | 150 | 3 | 33 |
| 33104 | 25 | 175 | 2 | 26 |
| 33104 | 30 | 100 | 20 | 155 |
| 33104 | 30 | 125 | 13 | 38 |
| 33104 | 30 | 150 | 4 | 50 |
| 33104 | 30 | 175 | 2 | 28 |
| 33104 | 80 | 100 | 45 | 200 |
| 33104 | 80 | 125 | 18 | 45 |
| 33104 | 80 | 150 | 6 | 55 |
| 33104 | 80 | 175 | 9 | 107 |
| 30163 | 25 | 125 | 20 | 130 |
| 30163 | 25 | 150 | 8 | 55 |
| 30163 | 25 | 175 | 11 | 35 |
| 30164 | 25 | 125 | 20 | 105 |
| 30164 | 25 | 150 | 7 | 33 |
| 30164 | 25 | 175 | 4 | 31 |
| 30124 | 25 | 125 | 16 | 108 |
| 30124 | 25 | 150 | 10 | 29 |
| 30124 | 25 | 175 | 4 | 13 |

It was observed that thinner materials dissolved more rapidly than thicker materials, and that elevated temperatures promoted faster dissolution rates. The pelleted products were more difficult to measure, but results of testing of those materials indicates that surface area is an important design metric affecting dissolution rates. The more surface area the material has, the greater the heat energy it absorbed and the faster it dissolved.

FIG. 5 shows a graphical representation of the dissolution time to 95% by surface area of the tested materials as a function of temperature. All of the materials dissolved faster at elevated temperatures and as the temperatures were lowered, it took longer for the samples to dissolve. Material 33104, denoted by the solid trendline, demonstrated the faster dissolution rate, even at lower temperatures (as compared to the other materials). It is noteworthy that material 33104 demonstrates the faster dissolution times at 25- and 30-micron thicknesses, however at 80 microns thickness it demonstrated the slower dissolution times. This supports a conclusion that thickness is a parameter (alongside of the composition of the material) that can be adjusted to provide desirable properties. In general, as the temperatures rose and material thickness decreased, the materials demonstrated faster dissolution times, with all materials demonstrating notable differences in speed of dissolution.

FIG. 6 shows a graphical representation of the dissolution time to 50% by surface area for the tested materials as a function of temperature. Similarly to FIG. 5, the materials demonstrated faster dissolution times at elevated temperatures and thinner compositions. The time it took for the materials to reach 50% dissolution was exponentially sooner than the time they took to reach 95% dissolution, especially where materials were thicker, or formulated to dissolve at higher temperatures. This supports a conclusion that the materials demonstrated that they dissolved quickly at first, then slowed in their rate of dissolution, especially when formulated to handle higher temperatures, or in thicker samples. Such properties of heat-releasable materials may be desirable for use in identification elements as described herein, allowing for more rapid breakdown of the device under artificial heating, or exposure to other surface areas of the device, to expedite the process of separating or removing or detaching from the subject (e.g. animal) or article (e.g. clothing) of interest.

Given the application of artificial heat energy through water (and/or flame) in typical animal/livestock processing facilities, these results support designs that are removable or detachable by existing processes and equipment with little or no additional intervention required in certain embodiments.

As will be understood, in certain embodiments identification elements as described herein may be configured to be removable or detachable by existing processes and equipment (such as scalding and/or singing processes and equipment, for example) with little or no additional intervention and/or modification. In certain embodiments, artificial heating itself may be sufficient to directly remove or detach the identification element most or all of the time. In certain embodiments, artificial heating may indirectly result in removal or detachment, whereby the artificial heating unfastens, weakens, loosens, or otherwise prepares the identification element for removal or detachment by one or more additional manipulations often routinely performed as part of existing operations (such as one or more washing, brushing, and/or polishing steps common in existing processes and equipment for meat processing, for example), or by one or more additional manipulations deliberately performed by a worker, tool, or machine to remove or detach the unfastened/weakened/loosened identification element, for example. Many meat processing operations often routinely involve washing, brushing, and/or polishing steps, any one or more of which may in certain embodiments apply force sufficient to remove an unfastened/weakened/loosened identification element, or portion thereof, if it somehow remained on the animal carcass following artificial heating, providing an extra layer of safety to prevent food contamination. In certain embodiments, line workers and/or inspectors may often be present on the line, and may remove any lingering unfastened/weakened/loosened identification elements, or portions thereof, if they were to occur, again providing even further barriers to prevent food contamination.

By way of example, some meat production facilities employ a brushing and polishing process which happens after a singing (flame-based hair burning) step. The brushing and polishing typically involves mechanical agitation with bristles and washing with pressurized water. In certain embodiments, it is contemplated that such brushing and polishing may remove or detach any unfastened/weakened/loosened identification element, or remaining debris/element/portion thereof, if it somehow remained on the animal carcass following artificial heating of the singing treatment. Remnant material (if any traces remain) may be monitored/removed by existing quality assurance workers as an added precaution, although it is preferred that identification elements be configured to provide for suitable removal or detachment during processing with minimal or no additional effort by workers.

In certain preferred embodiments, the identification elements as described herein may be configured to allow for automatic/passive removal or detachment as a result of treatment by existing processes of the particular implementation or facility with minimal or no modification, and with minimal or no additional effort by the workers. In meat processing, the most preferred or desirable identification element embodiments may include those configured such that standard scalding and/or singing operations performed for hair removal from the animal carcass also directly result in removal or detachment of the identification element (although embodiments where such scalding and/or singing operations indirectly result in removal or detachment of the identification element by unfastening, weakening, loosening, or otherwise preparing the identification element for removal or detachment by one or more additional manipulations such as washing, brushing, and/or polishing are also contemplated, for example). In certain embodiments, a deliberate dedicated step involving artificial heating may be performed specifically or primarily to remove or detach the identification element; however, it is often preferable for labour, cost, and/or environmental reasons that one or more existing process steps including artificial heating for various purpose(s) (such as hair removal) be sufficient to also result in removal or detachment of the identification element with minimal or no process step modifications.

These results identify suitable heat-releasable materials that may be used in attachment fittings of identification elements as described herein that may be used to provide for automatic/passive removal or detachment of the identification elements from livestock animals under standard scalding and/or flame/singing hair removal processes, for example.

All references cited in this specification are herein incorporated by reference in their entireties. One or more illustrative embodiments have been described by way of example. It will be understood to persons skilled in the art that a number of variations and modifications can be made without departing from the scope of the invention as defined in the claims.

1. An identification element for livestock, comprising:
an attachment fitting for securing the identification element to a livestock animal; and
a unique identifier element affixed to, integrated with, or embedded in the attachment fitting;
at least a portion of the attachment fitting being formed of a heat-releasable material which is solid at normal environmental temperatures, and which dissolves, melts, disintegrates, degrades, and/or evaporates upon artificial heating above normal environmental temperatures, such that artificial heating results in removal or detachment of the identification element from the livestock animal.

2. The identification element of claim 1, wherein the heat-releasable material dissolves, softens, melts, disintegrates, degrades, and/or evaporates upon artificial heating above a temperature of at least about 50° C. or the heat-releasable material dissolves, softens, melts, disintegrates, degrades, and/or evaporates upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more.

3. (canceled)

4. The identification element of claim 1, wherein the heat-releasable material completely dissolves, softens, melts, disintegrates, degrades, and/or evaporates upon artificial heating for about 1 hour or less, or the heat-releasable material completely dissolves, softens, melts, disintegrates, degrades, and/or evaporates upon artificial heating for 10 minutes, 9 minutes, 8 minutes, 7 minutes, 6 minutes, 5 minutes, 4 minutes, 3 minutes, 2 minutes, or less.

5. (canceled)

6. The identification element of claim 1, wherein the heat-releasable material comprises a polymer material or resin; or the heat-releasable material comprises a polyvinyl alcohol-based resin.

7. (canceled)

8. The identification element of claim 1, wherein the heat-releasable material comprises a solid polymer material or resin which dissolves or melts upon artificial heating by exposure to a heated liquid or gas; or the heat-releasable material comprises a solid polymer material or resin which dissolves or melts upon artificial heating by exposure to a heated water or steam.

9. (canceled)

10. The identification element of claim 1, wherein the heat-releasable material comprises a polyvinyl alcohol-based resin which is water insoluble at normal environmental temperatures, and which is water soluble upon heating above normal environmental temperatures; or wherein the heat-releasable material comprises a polyvinyl alcohol-based material which is substantially insoluble in water at temperatures up to at least about 40° C., and which becomes water soluble at a temperature no less than about 50° C.

11. The identification element of claim 10, wherein the polyvinyl alcohol-based resin is water soluble upon artificial heating above a temperature of at least about or the polyvinyl alcohol-based resin is water soluble upon artificial heating to 50° C. or higher, 51° C. or higher, 52° C. or higher, 53° C. or higher, 54° C. or higher, 55° C. or higher, 56° C. or higher, 57° C. or higher, 58° C. or higher, 59° C. or higher, 60° C. or higher, 61° C. or higher, 62° C. or higher, 63° C. or higher, 64° C. or higher, 65° C. or higher, 66° C. or higher, 67° C. or higher, 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, 79° C. or higher, or 80° C. or higher, or more.

12-13. (canceled)

14. The identification element of claim 1, wherein the heat-releasable material comprises a Hydropol™ polymer.

15. The identification element of claim 1, wherein the heat-releasable material comprises Hydropol™ 30124, 30163, 30164, or 33104.

16. The identification element of claim 1, wherein the identification element is in the form of a tag, band, bracelet, collar, spring, or clip.

17. The identification element of claim 1, wherein the attachment fitting comprises a rivet, snap, hook, tie, loop, strap, hinge, clip, pin, spring, latch, or other friction fit or fastening mechanism for securing the identification element to the livestock animal, wherein heating the heat-releasable material disengages or destroys the fastening mechanism, thereby removing or detaching the identification element from the livestock animal.

18. The identification element of claim 1, wherein all or substantially all of the attachment fitting is formed of the heat-releasable material.

19. The identification element of claim 1, wherein the unique identifier element comprises a label, barcode, RFID identifier, or any combination thereof and/or the unique identifier element comprises a label and/or barcode providing identifying details for the livestock animal readable visually, electronically, or both.

20. (canceled)

21. The identification element of claim 19, wherein the unique identifier element is fabricated of a material that dissolves, softens, melts, disintegrates, degrades, and/or evaporates upon artificial heating; or wherein the unique identifier element is resistant to artificial heating and is recoverable following removal or detachment of the identification element from the livestock animal.

22-24. (canceled)

25. A method for identifying and/or tracking a livestock animal, said method comprising:
securing the identification element as defined in claim 1 to the livestock animal;
using the identification element to uniquely identify and/or track the livestock animal over a period of time; and
removing or detaching the identification element from the livestock animal prior to or during production of meat from the animal.

26. The method of claim 25, wherein the step of removing or detaching comprises exposing the identification element to artificial heating and/or wherein the step of removing or detaching comprises a scalding or flame-based hair removal stage of a meat production process.

27-31. (canceled)

32. The identification element of claim 1 comprising:
the attachment fitting for securing the identification element to a livestock animal or other subject or article of interest; and
the unique identifier element affixed to, integrated with, or embedded in the attachment fitting;
wherein the attachment fitting remains secured to the livestock animal or other subject or article of interest under normal environmental temperatures, and wherein the attachment fitting is heat-releasable such that artificial heating above normal environmental temperatures results in removal or detachment of the identification element from the livestock animal or other subject or article of interest.

33. (canceled)

34. An implantable identification element for livestock or another subject or article of interest, comprising:
a housing; and
a unique identifier element affixed or joined to, integrated with, housed within, or embedded in the housing;
at least a portion of the housing being formed of a heat-releasable material which is solid at normal environmental temperatures, and which dissolves, softens, melts, disintegrates, degrades, and/or evaporates upon artificial heating above normal environmental temperatures, such that artificial heating results in removal of the identification element from the livestock animal/subject/article of interest, destruction of the identification element, or both.

35. The identification element of claim 1 comprising:
an outer protective barrier encompassing at least a portion of the unique identifier element, the outer protective barrier comprising at least one of: a film-type outer coating or layer; an outer sleeve or casing; or another outer coating, film, casing, or enclosure;
at least a portion of the outer protective barrier being heat-releasable, such that the outer protective barrier remains intact and provides protection of the unique identifier element under normal environmental temperatures, and releases or exposes the unique identifier element when subjected to artificial heating.

36. The identification element of claim 35, wherein at least a portion of the outer protective barrier comprises or is formed of a heat-releasable material which is solid at normal environmental temperatures, and which dissolves, softens, melts, disintegrates, degrades, and/or evaporates upon artificial heating above normal environmental temperatures.
